(19) United States
(12) Patent Application Publication
(10) Pub. No.: US 2016/0098520 A1
(43) Pub. Date: Apr. 7, 2016

(54) HEALTHCARE UTILIZATION VISUALIZATION

(71) Applicant: Consilink, LLC, Chicago, IL (US)

(72) Inventors: Cheryl Lulias, Evanston, IL (US); Kasu Sista, Oak Brook, IL (US); Annabelle E. Lim-Greene, Chicago, IL (US)

(21) Appl. No.: 14/506,553

(22) Filed: Oct. 3, 2014

(51) Int. Cl. G06F 19/00

(52) U.S. Cl. CPC G06F 19/322

(57) ABSTRACT

Provided is a system including a data store module is configured to store aggregated patient medical data collected from electronic devices associated with a number of discrete healthcare entities; and a data analytics module configured to calculate a metric, based on the aggregated patient medical data for each discrete healthcare entity of the number of discrete healthcare entities. The data analytics module is further configured to generate a report associated therewith. The system also includes a messaging module configured to transmit the report to one or more electronic devices associated with the number of discrete healthcare entities response to the report generation.

### BACKGROUND

Healthcare delivery is a patchwork of different healthcare providers (e.g., hospitals, medical homes, health insurance providers, etc.) all providing different services to patients. This patchwork leads to a lack of coordination between the healthcare providers, ultimately impacting their ability to attend to the needs of their patients. In addition, with implementation of the Affordable Care Act (ACA), healthcare providers are being rated based on outcome-based results. Consequently, healthcare providers are incentivized to provide higher quality healthcare that is outcome driven at a lower cost.

### SUMMARY

Accordingly, a need has arisen for a solution to improve patient care by reducing unnecessary hospital readmissions, inappropriate hospitalizations, poor chronic care management, and preventable emergency department visits. Further, there is a need to better leverage computing technology as a way of driving better coordination between healthcare providers and lowering treatment and delivery costs. For example, an information coordination system may be used to aggregate data stored by the different healthcare providers and portions of the aggregated data may be provided to the relevant healthcare providers to benchmark healthcare treatment and delivery. A report may be provided to the relevant healthcare providers.

According to some embodiments, a data store module is configured to store aggregated patient medical data collected from a number of discrete healthcare entities; and a data analytics module configured to calculate a metric based on the aggregated patient medical data for each discrete healthcare entity of the number of discrete healthcare entities generate a report associated with the metric. The system also includes a messaging module configured to transmit the report to the number of discrete healthcare entities.

According to some embodiments, a data analytics module is configured to calculate metrics associated with a healthcare entity and the metrics are based on patient medical data at the healthcare entity. The data analytics module is further configured to generate a report associated with the metrics and identify a metric that is outside of an acceptable range of a given threshold. The data analytics module is further configured to provide a recommendation to improve patient care and to reduce cost based on the report. A messaging module is configured to transmit the report to the healthcare entity,

According to some embodiments, a computer readable storage medium stores computer executable instructions that, if executed by a device cause the device to store aggregate patient medical data collected from a number of discrete healthcare entities; calculate a metric based on the aggregated patient medical data for each discrete healthcare entity and generate a report; and transmit the report to the discrete healthcare entities

These and other features and aspects may be better understood with reference to the following drawings, description, and appended claims.

### BRIEF DESCRIPTION OF DRAWINGS

FIG. 1 illustrates a report on a graphical user interface according to some embodiments.

FIG. 2 illustrates another report displayed on a graphical user interface according to some embodiments.

FIG. 3 illustrates a dashboard displayed on a graphical user interface according to some embodiments.

FIG. 4-9 illustrate reports displayed on a graphical user interface according to some embodiments.

FIGS. 10A-F illustrate operating environments according to some embodiments.

FIG. 11 illustrates a data flow diagram according to some embodiments.

FIG. 12 illustrates data interactions within an information coordination system according to some embodiments.

FIG. 13 illustrates a flow chart diagram for generating a report according to some embodiments.

FIG. 14 illustrates another flow chart diagram for generating a report according to some embodiments.

FIG. 15 illustrates a computer system according to some embodiments.

FIG. 16 illustrates a block diagram of another computer system according to some embodiments.

### DETAILED DESCRIPTION

Reference will now be made in detail to various embodiments, examples of which are illustrated in the accompanying drawings. While the claimed embodiments will be described in conjunction with various embodiments, it will be understood that these various embodiments are not intended to limit the scope of the embodiments. On the contrary, the claimed embodiments are intended to cover alternatives, modifications, and equivalents, which may be included within the scope of the appended Claims. Furthermore, in the following detailed description, numerous specific details are set forth in order to provide a thorough understanding of the claimed embodiments. However, it will be evident to one of ordinary skill in the art that the claimed embodiments may be practiced without these specific details. In other instances, well known methods, procedures, components, and circuits are not described in detail so that aspects of the claimed embodiments are not obscured.

Some portions of the detailed descriptions that follow are presented in terms of procedures, logic blocks, processing, and other symbolic representations of operations on data bits within a computer memory. These descriptions and representations are the means used by those skilled in the data processing arts and data communication arts to most effectively convey the substance of their work to others skilled in the art. In the present application, a procedure, logic block, process, or the like, is conceived to be a self-consistent sequence of operations or steps or instructions leading to a desired result. The operations or steps are those utilizing physical manipulations of physical quantities. Usually, although not necessarily, these quantities take the form of electrical or magnetic signals capable of being stored, transferred, combined, compared, and otherwise manipulated in a computer system or computing device. It has proven convenient at times, principally for reasons of common usage, to refer to these signals as transactions, bits, values, elements, symbols, characters, samples, pixels, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present disclosure, discussions utilizing terms such as “receiving,” “aggregating,” “transmitting,” “accessing,” “rendering,” “determining,” or the like, refer to actions and processes of a computer system or similar electronic computing device or processor. The computer system or similar electronic computing device manipulates and transforms data represented as physical (electronic) quantities within the computer system memories, registers or other such information storage, transmission or display devices.

It is appreciated that present systems and methods can be implemented in a variety of architectures and configurations. For example, present systems and methods can be implemented as part of a distributed computing environment, a cloud computing environment, a client server environment, etc. Embodiments described herein may be discussed in the general context of computer-executable instructions residing on some form of computer-readable storage medium, such as program modules, executed by one or more computers, computing devices, or other devices. By way of example, and not limitation, computer-readable storage media may comprise computer storage media and communication media. Generally, program modules include routines, programs, objects, components, data structures, etc., that perform particular tasks or implement particular abstract data types. The functionality of the program modules may be combined or distributed as desired in various embodiments.

Computer storage media can include volatile and nonvolatile, removable and non-removable media implemented in any method or technology for storage of information such as computer-readable instructions, data structures, program modules, or other data. Computer storage media can include, but is not limited to, random access memory (RAM), read only memory (ROM), electrically erasable programmable ROM (EEPROM), flash memory, or other memory technology, compact disk ROM (CD-ROM), digital versatile disks (DVDs) or other optical storage, magnetic cassettes, magnetic tape, magnetic disk storage or other magnetic storage devices, or any other medium that can be used to store the desired information and that can be accessed to retrieve that information.

Communication media can embody computer-executable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media can include wired media such as a wired network or direct-wired connection, and wireless media such as acoustic, radio frequency (RF), infrared and other wireless media. Combinations of any of the above can also be included within the scope of computer-readable storage media.

With the implementation of the Affordable Care Act (ACA), focus has increased on the quality of treatment, and healthcare metrics are increasingly becoming outcome based or accountable based. For example, hospitals are penalized for patient readmissions within 30 days, whether the original admission was by the same hospital or a different hospital. As a result, healthcare providers are looking to improve efficiency, effectiveness, and quality of patient care.

In some embodiments, patients are assigned to particular healthcare providers (e.g. PCPs, clinics, hospitals, etc.) for their healthcare needs. However, should a patient visit a different health care provider (e.g. PCP, clinic, hospital, etc.), the assigned healthcare provider has no way of being notified of this recent activity because, for example, the clinics and the hospitals are disparate healthcare organizations and do not share information with one another. In other words, healthcare providers maintain and keep a timeline of a patient's individual record (e.g. “longitudinal data”) without sharing it between different providers. Accordingly, appropriate steps cannot be taken between different healthcare providers to improve patient care and reduce readmission rates (e.g., at hospitals).

Provided herein are embodiments for aggregating patient data that is generated by disparate healthcare organizations. The aggregated patient data from disparate healthcare organizations is stored for later retrieval by an information coordination system, in one instance. In some embodiments, patient data from non-disparate healthcare organizations may also be aggregated and stored for later retrieval. It is appreciated that patient information may include but is not limited to historical prescription and medical claims data, patient diagnosis, patient diseases, physical examination, etc. Furthermore, any references to hospitals, clinics, etc. are references to their computers, servers, electronic devices, etc., that store electronic information. Although this disclosure illustrates and describes interaction between healthcare entities and an information coordination system, this disclosure contemplates and includes the interactions between any suitable electronic devices of the healthcare entities with any suitable electronic devices of the information coordination system, for example, desktop computers or tablets at hospitals communicating with a hospital storage device or a clinic storage device communicating with a server of the information coordination system. Such interactions are contemplated throughout the disclosure. Any references to servers of the healthcare entities or information coordination system are exemplary and contemplates the use of any suitable electronic device such as a single-board computer system (SBC), for example computer-on-module (COM) or system-on-module (SOM), a laptop or notebook computer system, a mobile telephone, a smartphone, a personal digital assistant (PDA), a tablet computer system, etc.

Relevant information from the aggregated patient data may be transmitted to other providers (e.g., clinics (assigned or not), hospitals, etc.), in order to improve patient care (e.g., by the assigned clinic making follow up appointments after a hospital visit, by reminding the patient to pick up medication, assigning and referring the patient to a clinic if the patient is not assigned to a clinic, etc.). It is appreciated that embodiments described with respect to patient data is not limited to specific medical information and the use of specific medical information is for illustrative purposes. As such, using specific medical information as illustrated by the accompanying figures are illustrative and non-limiting. For example, any type of information associated with a patient may be used, e.g., biometric information, social services information, patient feedback data, etc., may also be used.

As a result, care coordination between healthcare providers and patients becomes more effective, and in turn improves healthcare quality and reduces cost by reducing readmission rates. Furthermore, reducing unnecessary readmission rates reduces health care providers' financial penalties, thereby increasing profits.

In some embodiments, the transfer of data may be implemented through a web-based portal. As another example, the information coordination system and/or the assigned clinic may transmit reminders to patients who had a recent hospital stay or visit to the emergency department (ED) to perform follow-up visits with their clinic. Herein, reference to healthcare entities may refer to hospitals, centers for Medicare and Medicaid Services (CMS), States, clinics, health-information exchanges, insurance companies, payors, etc. that provide healthcare services to patients. It is appreciated that the aggregated patient data may be transmitted to a server of a healthcare entity, whilst the aggregated patient data may be further transmitted to lower level providers of service within the healthcare entity that performs the actual intervention. Additionally, reference to near real-time data may refer to data that is separate from medical claims data obtained from, for example, CMS or health information exchanges, etc. such that transmission or reception of data from a first computing system is within a period of time (e.g., thirty minutes, an hour, etc.) of the data being entered into a second computing system. In some embodiments, the information coordination system may use the aggregated data to generate a utilization report in order to illustrate the performance of the healthcare entities. As such, the quality and cost of medical treatment, as well as highlight areas where performance may be improved.

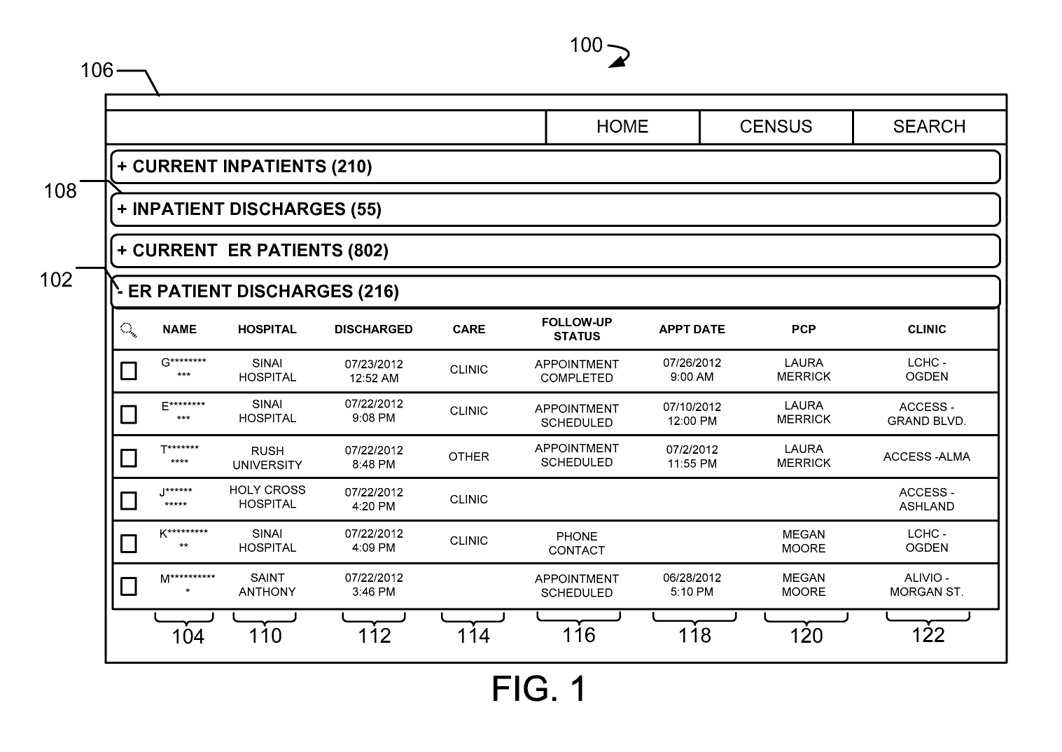

FIG. 1 illustrates a report on a graphical user interface according to some embodiments. Although this disclosure illustrates and describes display of a report on a graphical user interface (GUI), this disclosure contemplates any report illustrated or described in the disclosure taking any suitable form, for example a paper copy, a downloaded file, hyperlink, etc. Such forms are contemplated throughout the disclosure. Furthermore, although this disclosure illustrates and describes GUIs having a specific configuration of graphical elements or icons, this disclosure contemplates any suitable GUI having any suitable configuration of graphical elements or icons. In some embodiments, the status report may be included as part of a utilization report of a healthcare entity (e.g., a hospital or clinic) to providing information or metrics of the quality and cost of medical treatment, as well as highlight areas where performance may be improved.

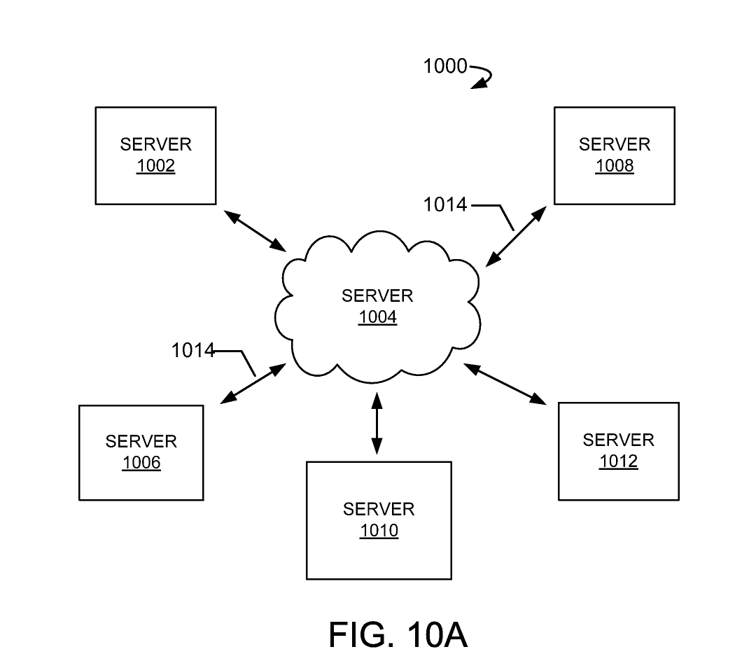

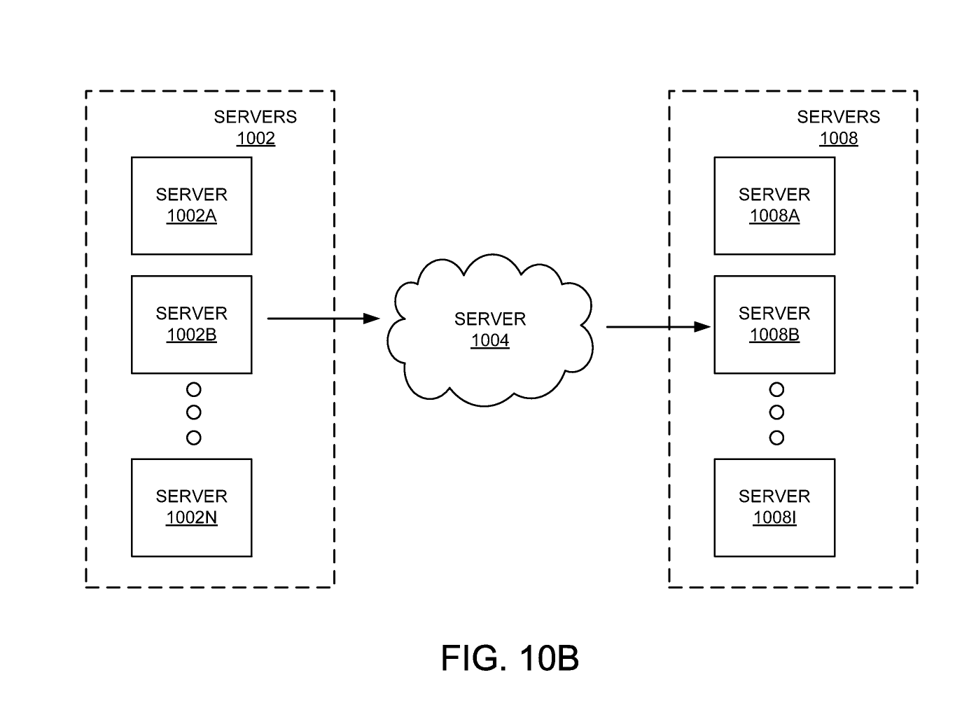

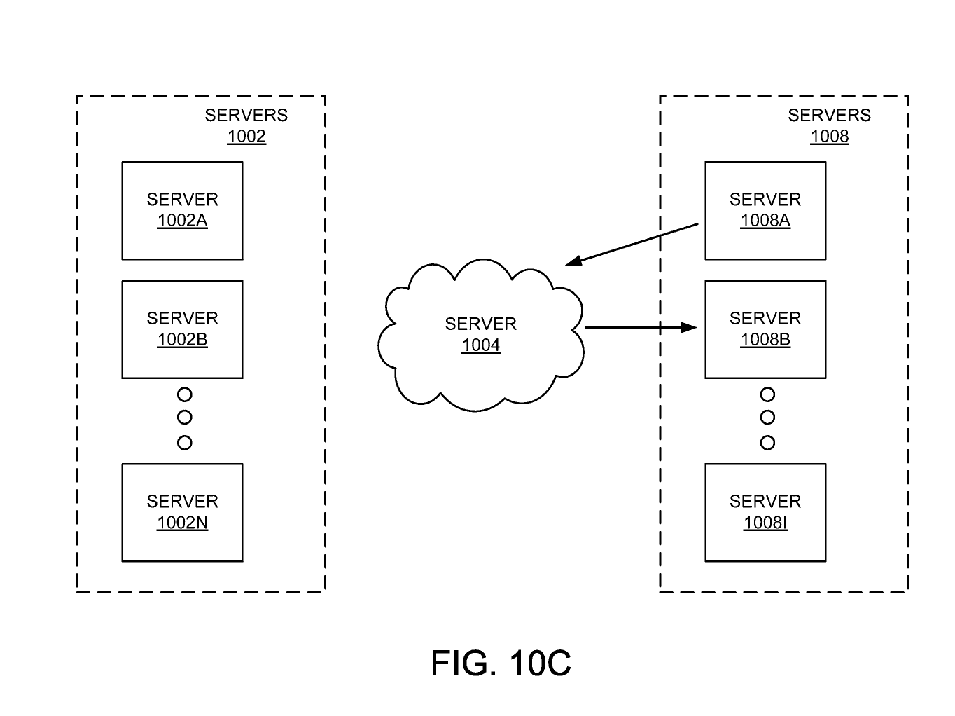

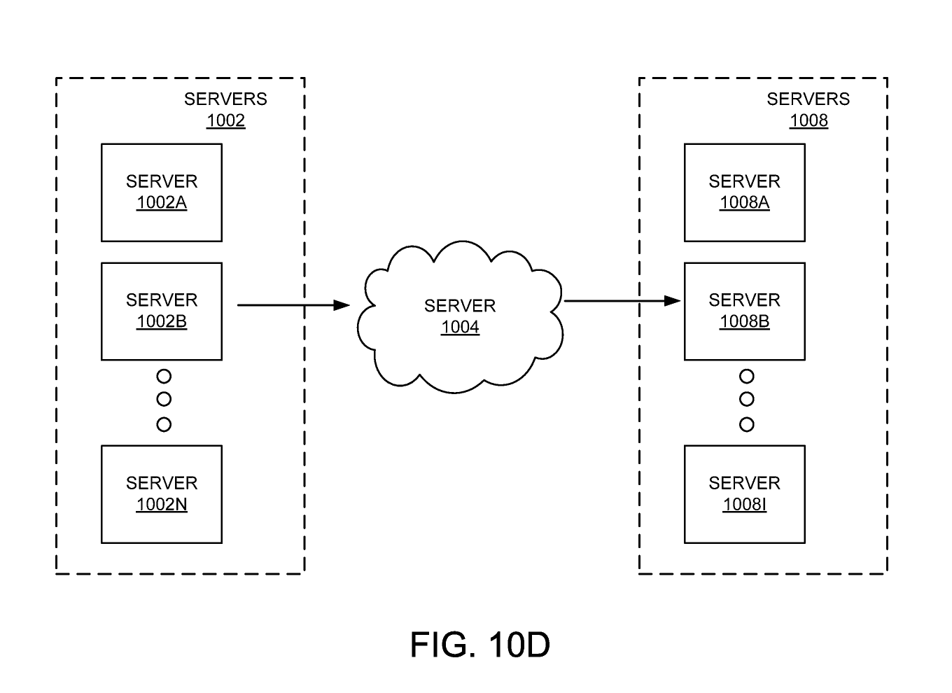

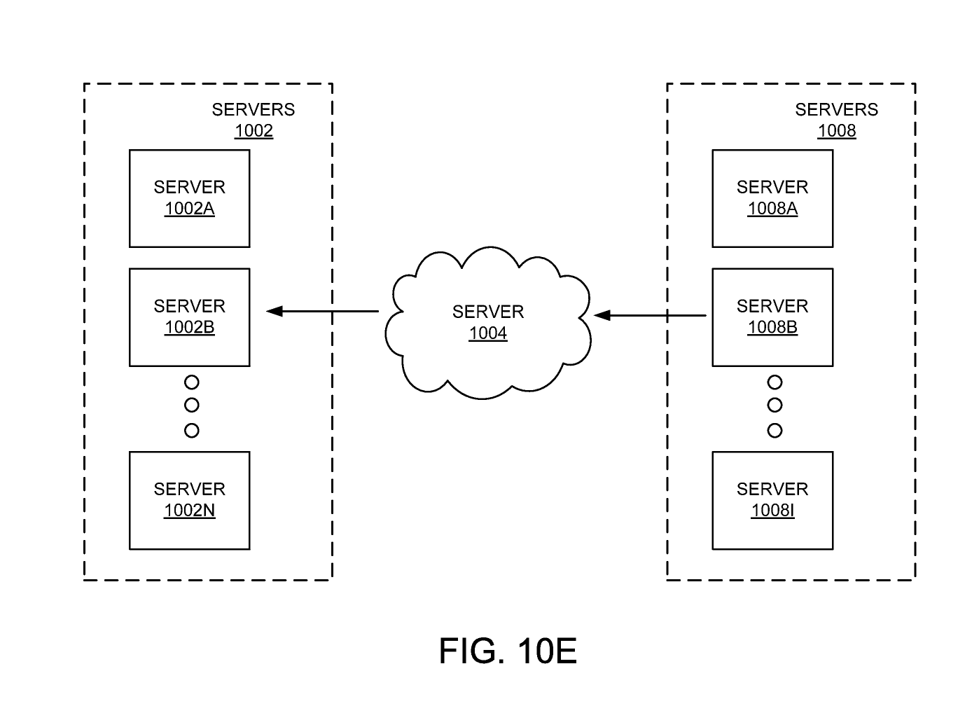

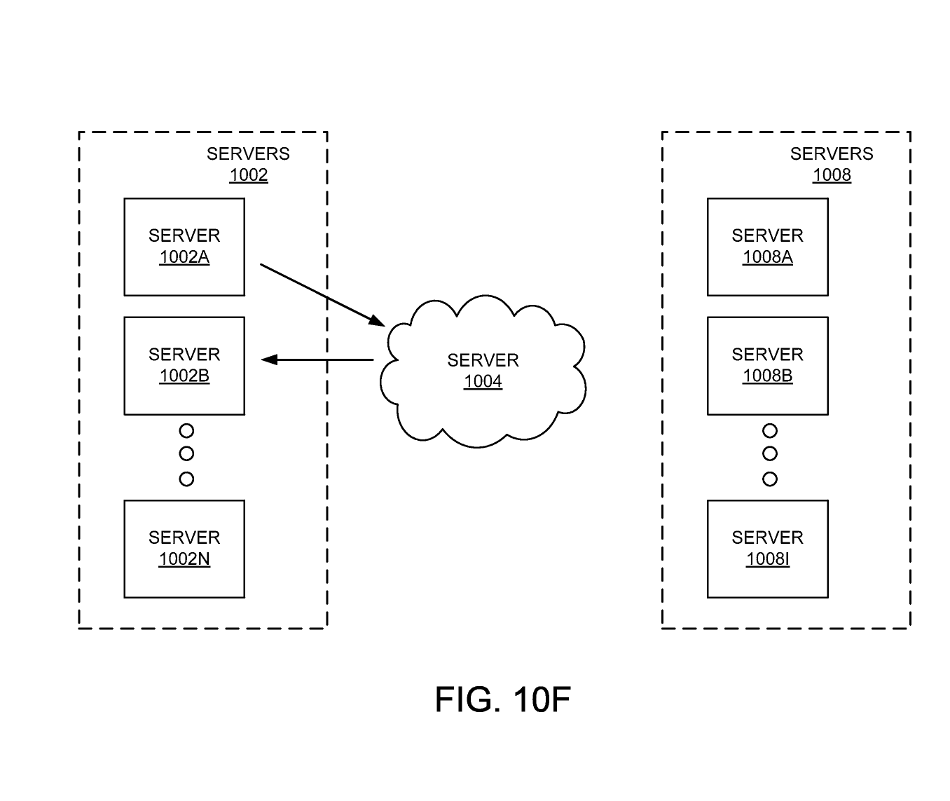

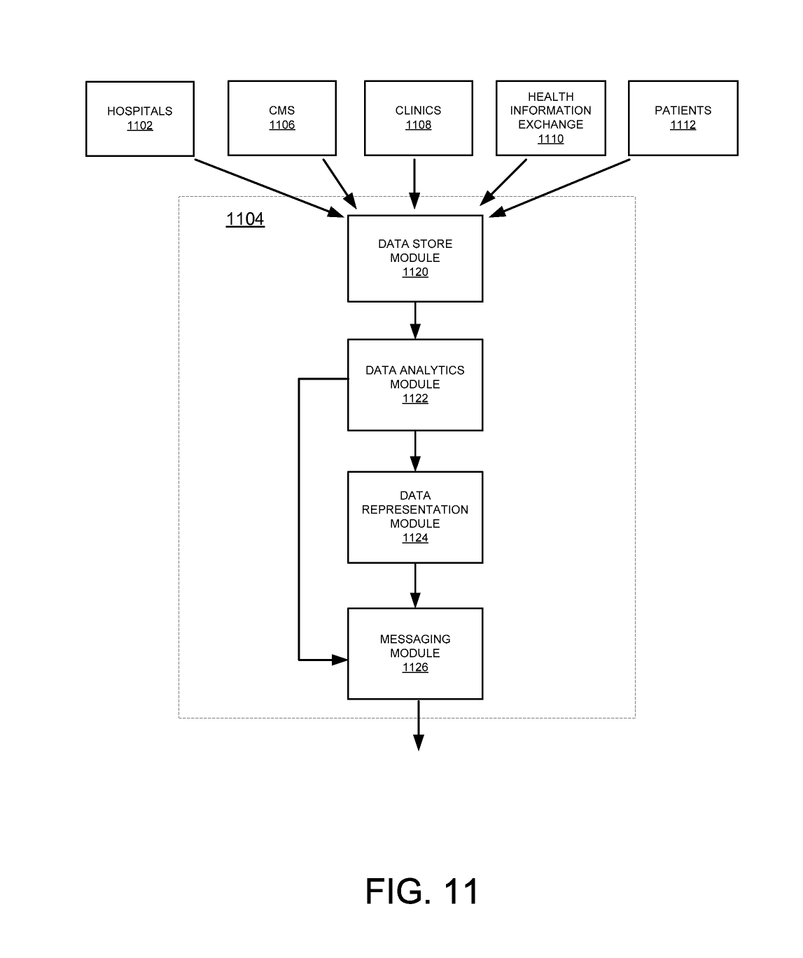

The information coordination system, described below in FIG. 10A and FIG. 11, may provide a GUI 100 to monitor the current status of patients. In some embodiments, GUI 100 may provide information of patients based on their classification into various patient categories 108, for example current inpatients, inpatient discharges, current emergency room (ER) patients, ER patient discharges, etc. It is appreciated that selection of categories 108 may provide additional detailed information of patients. It is further appreciated that the terms “emergency room” (ER) and “emergency department” (ED) may be used interchangeably as appropriate. As an example, the additional detailed information belonging to an inpatient discharges category may be accessed through actuation of an icon 102 (e.g., expand or collapse icon) displayed on GUI 100. It is appreciated that additional information regarding other categories 108 may similarly be provided.

Actuating icon 102 may initiate presentation of a display area 104 with information of patients classified in a category 108. As an example, actuating icon 102 for ER patient discharges category may expand the category 108 and provide the information displayed in display area 104. For example, each expanded category 108 may include a member 104 field, hospital 110 field, discharge 112 field, care 114 field, follow-up status 116 field, appointment date 118, primary care physician (PCP) 120 field, and clinic 122 field. Member 104 field may include information regarding the member, e.g., member identification, member name, member date of birth, member telephone number, member address, etc. Hospital 110 field may indicate the hospital that the member was discharged.

The care 114 field may indicate whether the member is assigned to a clinic or not. For example, if a member is not assigned to a clinic, a computing device may trigger an alert for the hospital to refer the member to a clinic for follow-up care. The generated trigger may be an alert, e.g., an email, phone call, fax, etc., sent via a device, e.g., smart phone, computing device, pager, telephone, email exchange server, etc., to the appropriate personnel in the hospital.

Follow-up status 116 may indicate whether the member has performed one or more follow-up procedures. For example, a member may have completed a follow-up visit with their PCP, is unreachable, may have inaccurate patient information on file, declined a scheduled follow-up appointment with their PCP, etc. The follow-up status 618 may trigger an alert, e.g., an email, phone call, fax, etc., to be sent via a device, e.g., smart phone, computing device, pager, telephone, email exchange server, etc., to the appropriate personnel to flag a member for additional follow-up. Appointment date 118 may indicate the date and time in which the member has a scheduled appointment at their assigned clinic for a follow-up visit. PCP 120 and clinic 122 fields may indicate the primary care physician and clinic, respectively, that a member is assigned and associated with.

Such a report 106 may be implemented, for example, in a hospital, wherein hospital administration personnel may see detailed information of the follow-up status of discharged patients relative to that of other hospitals. As an example, a hospital administrator at Sinai Hospital may see that over a period of time three patients were recently discharged from the hospital. The hospital administrator may view follow-up status 116 and determine that a patient has completed their follow-up visit with their PCP, another patient has an appointment scheduled, and a third patient has been contacted to schedule to a follow-up visit with their PCP. In addition, the hospital administrator may determine that each of the three patients has been assigned to a clinic and which clinic each patient was assigned to. In some embodiments, follow-up practice may be modified based on the status reports. For example, hospitals may incentivize clinics to offer a modified time slot that may better fit the patients schedule or a longer time slot for the initial follow-up visit to new patients.

In various embodiments, the rendered information on GUI 100 may be used for monitoring the health status and providing near real-time access to data associated with patients and their care. In some embodiments, GUI 100 may allow for review of current medical data or status of the patient, historical medical data of the patient, etc. As an example, one or more fields of display area 104 may be selected to provide additional detailed information of the data in the field (e.g., as a hyperlink). For example, selecting the name of a patient may initiate display (e.g., as a pop-up display or another webpage) the data (e.g., age, gender, medical history, medical conditions, etc.) of the patient. As another example, GUI 100 may allow viewing of an image or video footage (e.g., motion or still images) corresponding to medical data of the patient (e.g., ultrasound data, magnetic resonant imaging (MRI), computed tomography (CT) scans, etc.). For example, patient's last hospital visit, patient's last clinic visit, patient's reason for hospital visit, diagnosis, prescription, discharge date, the number of times patient has been admitted to the hospital, whether it was the same hospital or different hospitals. According to some embodiments, a computing system such as the information coordination system (described in detail in FIGS. 10A and 11) may identify a pertinent department or an appropriate individual at the hospital. According to some embodiments, the information coordination system (e.g., a computing system) may send a link associated with the GUI to the identified department or appropriate individual, so that the data may be analyzed to determine if modifications to the operation of the hospital should be undertaken. It is appreciated that information associated with the GUI may be transmitted through paper output, text, email, phone call, etc.

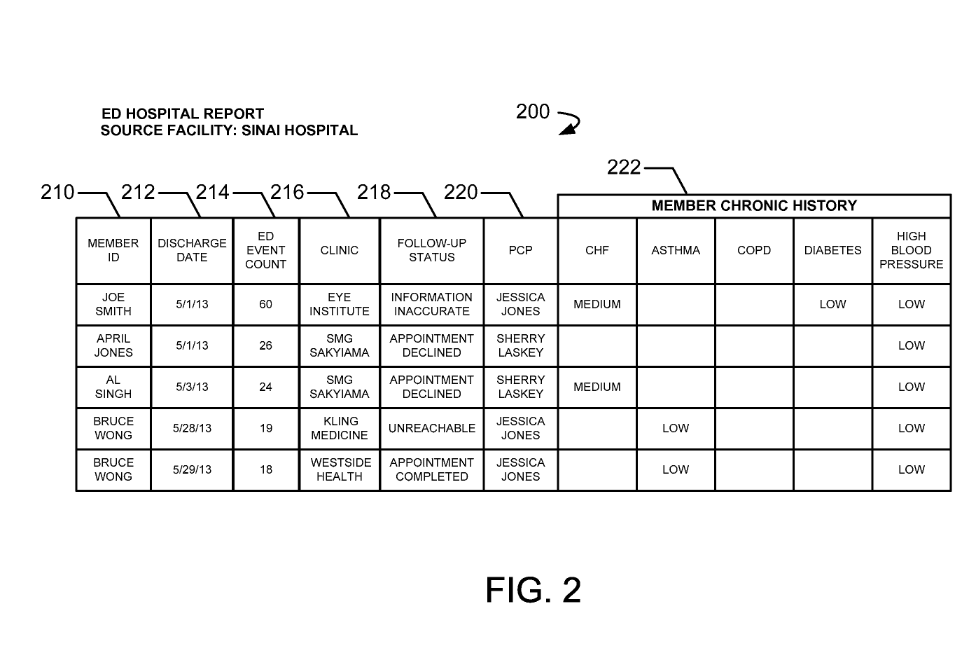

FIG. 2 illustrates another report displayed on a graphical user interface according to some embodiments. In some embodiments, alert report 600 may alert clinics that one of their assigned patients has recently been discharged from the ED of a hospital. According to some embodiments, report 200 may include an member identification (ID) field 210, discharge date 212 field, ED event count 214 field, clinic 216 field, follow-up status 218 field, primary care physician (PCP) 220 field, and member chronic condition history 222. Member identification 210 field may include information regarding the member, e.g., member identification number, member name, member date of birth, member telephone number, member address, etc.

The discharge date 212 may indicate the date and time that the member was discharged from the ED of a hospital. Report 200 may display calculated metrics, for example ED event 214 count that may provide insight into the effectiveness of healthcare treatments for each patient or identify one or more patients that may require more extensive follow-up treatment(s). Number of ED counts 214 may indicate the number of times that the member has visited the ED of a hospital. It is appreciated that ED count 214 may occur over a period of time (e.g., 90 days). In some embodiments, a patient with an ED count 214 above a threshold value may be considered a “frequent flyer” or having an unacceptable amount of treatments being performed at the ED rather than through their clinic. A hospital administrator may work with the patient care coordinator of the assigned clinic to more closely monitor the aftercare treatment of the identified patient. For instance, patients may receive more frequent phone calls or short-message service (SMS) messages reminding the identified patient about follow-up visits with their PCP. As an example, the threshold number of ED visits may be manually set (e.g., by a primary care coordinator of a clinic, by the hospital, etc.). As another example, the threshold number of ED visits may be set by a computing system based on heuristics. For example, the threshold number of ED visits may be set based on an average number of ED visits for other patients with similar demographics (e.g., age, ethnicity, gender, etc.). It is appreciated that the patients may then be prioritized and hierarchically ordered by the information coordination system based on the number ED visits, for instance. However, it is appreciated that information coordination system generating report 200 may prioritize or hierarchically order patients in the report based on any suitable criteria, which may be user selectable and/or modifiable. As an example, the information coordination system may determine a number of ED visits for each patient and order the information regarding the patient in report 200 based on the determined number of ED visits. In some embodiments, the information coordination system may prioritize and hierarchically order patients based on heuristics. Report 200 may include information of the assigned PCP for each patient.

Clinic 216 field may indicate the clinic that the member is assigned and associated with. Follow-up status 218 may indicate whether the member has performed one or more follow-up procedures. For example, a member may have completed a follow-up visit with their PCP, is unreachable, may have inaccurate patient information on file, declined a scheduled follow-up appointment with their PCP, etc. The follow-up status 218 may trigger an alert, e.g., an email, phone call, fax, etc., to be sent via a device, e.g., smart phone, computing device, pager, telephone, email exchange server, etc., to the appropriate personnel to flag a member for additional follow-up. PCP 220 field may indicate the primary care physician that a member is assigned and associated with.

As described above, member chronic condition history 222 may indicate one or more chronic conditions (e.g., CHF, asthma, COPD, diabetes, high-blood pressure, etc.) for which each patient may be undergoing treatment. It is appreciated that the number of chronic condition fields may be user selectable and may be varied. For example, in some embodiments, the top seven chronic conditions may be displayed. In other embodiment, in response to a user selection, additional chronic condition may be displayed. In other words, in response to a user selection additional information associated with a patient may be displayed whether that information is related to the chronic history or any other patient attribute. The information of chronic conditions may further include an indicator (e.g., color or status) of the severity of the chronic condition. It is appreciated that the computing system analyzing the member's information and data associated therewith may prioritize and sorted based on heuristics to select the top five chronic conditions, e.g., based on severity of the condition. It is, however, appreciated that the conditions may be sorted based on any criteria and is not necessarily limited to the severity of the conditions. However, it is appreciated that the patients may be prioritized or hierarchically ordered in the report based on any criteria, which may be user modifiable.

In some embodiments, a component of the information coordination system may indicate or flag a diagnosed chronic condition being presented or the severity of the chronic condition to alert a coordinator that a follow-up procedure may need to be modified. As an example, a visual indication on report 200 may indicate that a patient is suffering from a chronic condition may require more intensive follow-up than other patients discharged from the ED. As another example, the hospital administrator may try to get a patient assigned to a clinic to be better able to treat the chronic condition that was presented at the ED. In one instance, a patient that was discharged from the ED of the hospital and suffering from diabetes may be prescribed a restricted diet to manage the chronic condition and may be assigned to a clinic with a dietitian on staff to assist the patient with designing a diet that will best work with their eating habits.

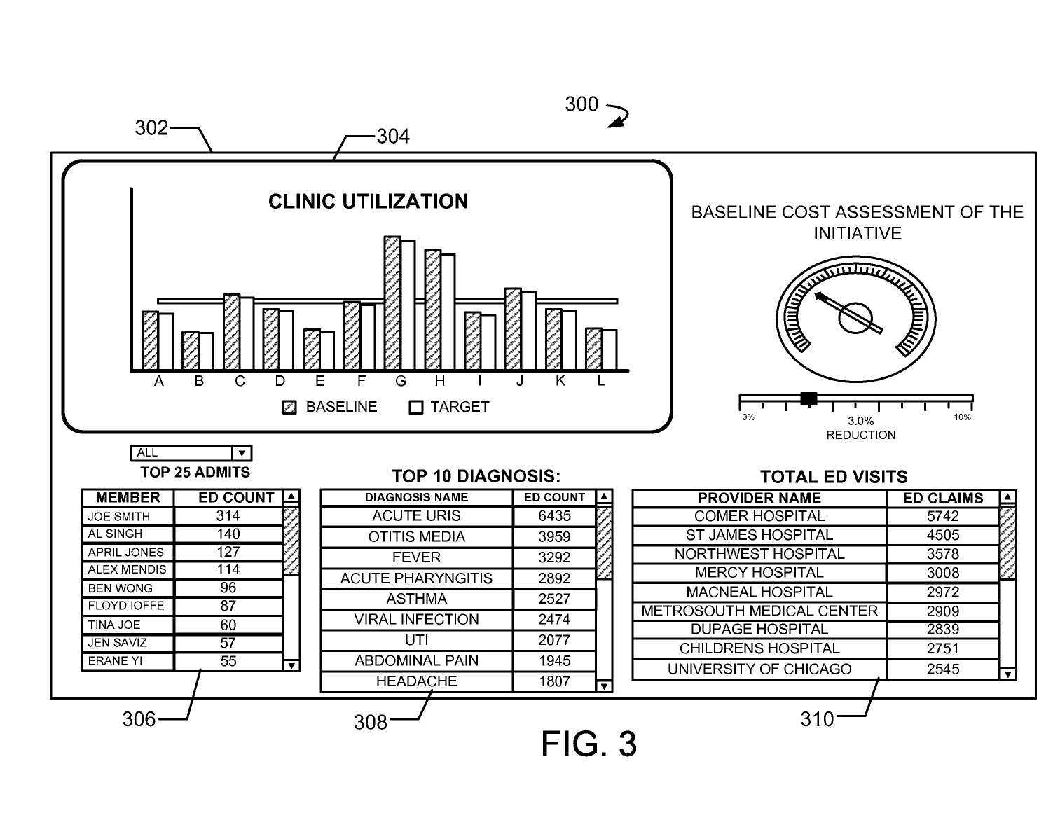

FIG. 3 illustrates a dashboard displayed on a graphical user interface according to some embodiments. In some embodiments, dashboard 302 may be included as part of a utilization report or displayed on a GUI 300. In some embodiments, dashboard 302 may include top admissions 306 area, top diagnosis 308 area, total ED visits 310 area, and patient utilization of various clinics 304 area. Top admissions 306 area may include information identifying specific patients that have the highest number of ED admissions over a period of time (“frequent flyers”), the ED count, etc. Top diagnosis 308 area may include information regarding the medical conditions with the highest number of diagnosis, the number of ED visits associated with each diagnosis, etc. Total ED visits 308 area may include information regarding the healthcare entities (e.g., hospitals) with the highest number of ED visits, the number of ED claims for each healthcare entity, etc. It is appreciated that listing of 25 patients having the most ED admissions and listing of 10 diagnoses are illustrative and should not be construed as limiting the embodiments.

In some embodiments, dashboard 302 may use one or more metrics to provide insight into the performance of the healthcare entity. For example, “frequent flyers” may be identified, the patients with medical conditions with the highest number of diagnosis may be identified, etc. A hospital administrator may use utilization dashboard 300 to analyze the performance at a hospital and possibly adjust the operation of the hospital or how the hospital interacts with the assigned clinics. As an example, a hospital administrator may be interested in benchmarking the performance of the ED of the hospital and dashboard 302 may be used as part of the analysis. As an example, the information coordination system may rank the various conditions diagnosed in the ED of a hospital and provide a visual indication (e.g., highlighting, underlining, etc.) which medical conditions may be of particular interest to reduce the ED count.

Although this disclosure provides references to particular medical conditions, e.g., asthma, etc., these medical conditions are for illustrative purposes only and any suitable medical conditions may be similarly analyzed. Dashboard 302 may include metrics that may provide a snapshot of the number of diagnoses of various types being treated at the ED through the information of top diagnosis 308 area. In some embodiments, a computing system of the information coordination system may access the data of the hospitals, associate the data with particular diagnoses, and calculate a number of ED visits are associated with each diagnoses. As an example, the ED may treat over 6,400 acute uris (upper respiratory infections) cases over a time period of interest, which may be significantly higher than the next most common diagnosis. The hospital administrator may benchmark this number of acute uris cases with the number of acute uris cases diagnosed at other hospitals. As an example, the number of acute uris cases may be on par with the number of cases diagnosed at other hospitals, so in the short term the hospital administrator may take no additional steps to address this. In the long-term, the hospital administrator may initiate a preventative outreach program to encourage people in their community to be vaccinated (e.g., flu vaccination) in order to reduce the number of cases.

In some embodiments, dashboard 302 may include a comparison relative to other hospitals using information from total ED visits 310 area described above. In some embodiments, a computing system of the information coordination system may access the data of the patients, associate the data (e.g., ICD codes) with a visit to the ED, and calculate a number of ED visits for each hospital. Hospitals may file claims for procedures or diagnoses of a patient that may be described using the international classification of diseases (ICD) codes, where a common revision of the ICD codes is revision 9 or revision 10 (ICD-9 or ICD-10 codes). The total number of visits to the ED of the hospital may be compared to the number of visits at the ED of other hospitals over the same period of time. In one instance, a hospital with a significantly higher number of ED visits than the other hospitals being benchmarked may analyze the data of the diagnosis with the highest number of occurrences (e.g., acute uris) and take measures to prevent (e.g., vaccination) and ultimately reduce the number of cases.

In some embodiments, the information coordination system may access the data of the patients, associate the particular data (e.g., ICD codes) with a visit to the ED, and identify patients that previously revisited the ED within a certain threshold of time and present the data in top admission 306 area. The information coordination system may then calculate a number of ED visits for each hospital, and further calculate the percentage of the visits to the ED that are readmissions. The information coordination system may also be configured to calculate the number of ED visits for each hospital and further calculate the percentage of the visits to the ED that are readmissions related to the same issue. As an example, the hospital administrator may determine the percentage of visits to the ED are readmissions and if the percentage of readmissions is above a certain threshold, the hospital administrator may implement additional follow-up programs (e.g., encourage annual check-ups) to reduce the readmission rate. In some embodiments, the healthcare entities used as the benchmarks may be selected based on having a similar number of beds, staff, patients, procedures, etc., as the healthcare entity being studied.

In some embodiments, dashboard 302 may identify patients with particular behavioral patterns, for example patients that seek treatment at the ED of a hospital. As described above, a hospital administrator may identify patients who are treated in the ED at a rate higher than average or above any given threshold and may work in conjunction with the assigned clinics to perform more intensive outreach to patients identified as being a “frequent flyer”. As another example, the hospital administrator may select a field with a patient identifier to view additional detailed information of the patient status and history, for example through a report 200, as described in FIG. 2. In other embodiments, the information coordination system may initiate mailing of a physical copy of information associated with dashboard 302 and highlighting information of interest. It is appreciated that information associated with the GUI may be transmitted through a hyperlink, text, email, phone call, etc.

In some embodiments, report 300 may be used to benchmark patient utilization of various clinics. As an example, clinic utilization may be a metric that measures a number of patient visits, patients, etc. In one instance, clinic utilization 304 area may include a graph that plots a baseline number of patient visits of various clinics compared to a target number of patient visits for each clinic. In another instance, the baseline number of patient visits for various clinics may be compared to a value that is the average of the baseline number of all of the clinics being benchmarked. For example, a hospital administrator may determine that clinic F has a baseline number of patient visits that is above their target number of patient visits and is on par with the average baseline value of all the clinics. On the other hand, clinic B while having a baseline value that meets their target, but is significantly lower than the average baseline value of all the clinics. In other words, clinic B may be capable of servicing additional patients, but their target is being set too conservatively. The hospital administrator may wish to interact with the clinic to encourage them to take on additional patients.

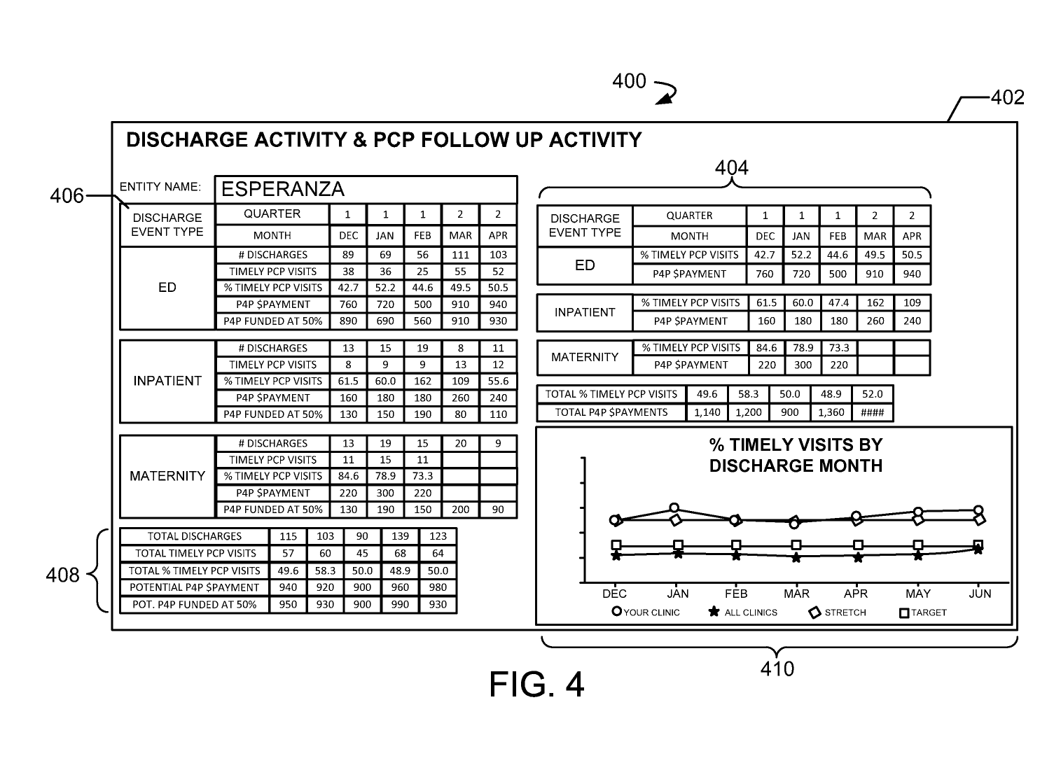

FIG. 4 illustrates a report displayed on a graphical user interface according to some embodiments. In some embodiments, report 402 may be included as part of a utilization report or displayed on a GUI 400. In some embodiments, report 402 may include a summary 404 of a percentage of timely PCP visit for patients that visited the hospital, amount of payments, the month associated with the data, the quarter of the data, etc. categorized by event type (e.g., ED visit, inpatient, maternity, etc). In some embodiments, report 402 may include a summary 404 of a percentage of timely PCP visit for patients that visited the hospital, amount of payments, the month associated with the data, the quarter of the data, etc. categorized by event type (e.g., ED visit, inpatient, maternity, etc). In some embodiments, report 402 may include an expanded summary 406 that may include the number of patient discharges, and payment information funded at 50% of the cost of the procedure categorized by event type (e.g., ED visit, inpatient, maternity, etc), in addition to the data of summary 404. Furthermore, summary 406 may include data associated with different procedures. For example, a number of patients discharged after undergoing various treatments, a number of follow-up visits with the patients' PCP, the rate of follow-up visits with the patients' PCP, the amount of money associated with pay for performance (P4P), described below, for each type procedure, the amount of money with a given P4P reimbursement rate. etc.

Totals 408 area may include data regarding the total number of discharges, timely PCP visits, total percentage of timely PCP visits, potential pay for performance (P4P) payments, etc. Timely follow-up visits 410 area may include information regarding the percentage of patients discharged from a healthcare entity (e.g., hospital) performed timely follow-up visits. It is appreciated that graph illustrating the percentage of timely visits by months is illustrative and should not be construed as limiting the embodiments.

In some embodiments, report 402 may be included as part of a utilization report of a hospital. A hospital administrator may use report 402 to analyze the performance at the hospital and possibly adjust the operation of the hospital. As an example, a hospital administrator may be interested in benchmarking the performance of the various departments of the hospital and may use report 402 as part of the analysis. As an example, a hospital administrator may analyze the performance and workload of various departments of the hospital. As an example, the information coordination system may provide a visual indication (e.g., highlighting, underlining, etc.) on report 402 for medical conditions that may be of particular interest (e.g., based on a calculated threshold number of ED visits) in order to reduce the ED count. In one instance, the ED of the hospital may have the highest number of discharges, but relatively low percentage of timely PCP visits. The hospital administrator may realize that the relatively low percentage of timely PCP visits may be due to the ED department being understaffed for the number of discharges they handle. in addition, the administrator may determine that the percentage of timely follow-up visits is relatively low and programs are needed to encourage better patient follow-up.

In another instance, the maternity department may have a relatively low number of discharges, but relatively high percentage of timely PCP visits. As an example, the information coordination system may send an e-mail or text detailing which departments of the hospital are under-utilized based on the data of summaries 404 or 406. The hospital administrator may determine that based on the number of patient discharges that the maternity is being under-utilized and initiate an effort to encourage more patients to use the maternity ward of the hospital. As an example, the information coordination system may transmit an e-mail with a link to a webpage that describes various outreach initiates undertaken by other health care entities may be implemented to encourage more patients to use the maternity ward of the hospital.

Under P4P, healthcare providers are rewarded for meeting pre-established targets for delivery of healthcare services. As an example, in order to meet such targets, the hospital administrator may use report 402 to determine which type of procedures performed at the hospital are meeting P4P goals. In addition, the hospital administrator may determine a trend of how the various departments are meeting these goals over time. In one instance, it may be determined that the maternity department has relatively high P4P payments compared the ED when averaged by the number of discharges or any suitable metric. As an example, the information coordination system may provide a visual indication on report 402 (e.g., highlighting, underlining, etc.) emphasizing the data associated with the maternity department based on determining that the amount of P4P payments averaged by the number of discharges is above a given threshold. Based on this information, the hospital may decide to expand their maternity department to try to increase the amount of maternity patients treated at the hospital. In addition, report 402 may include information related a comparison of timely follow-up visits with other clinics, targets, stretch or ambitious targets, etc.

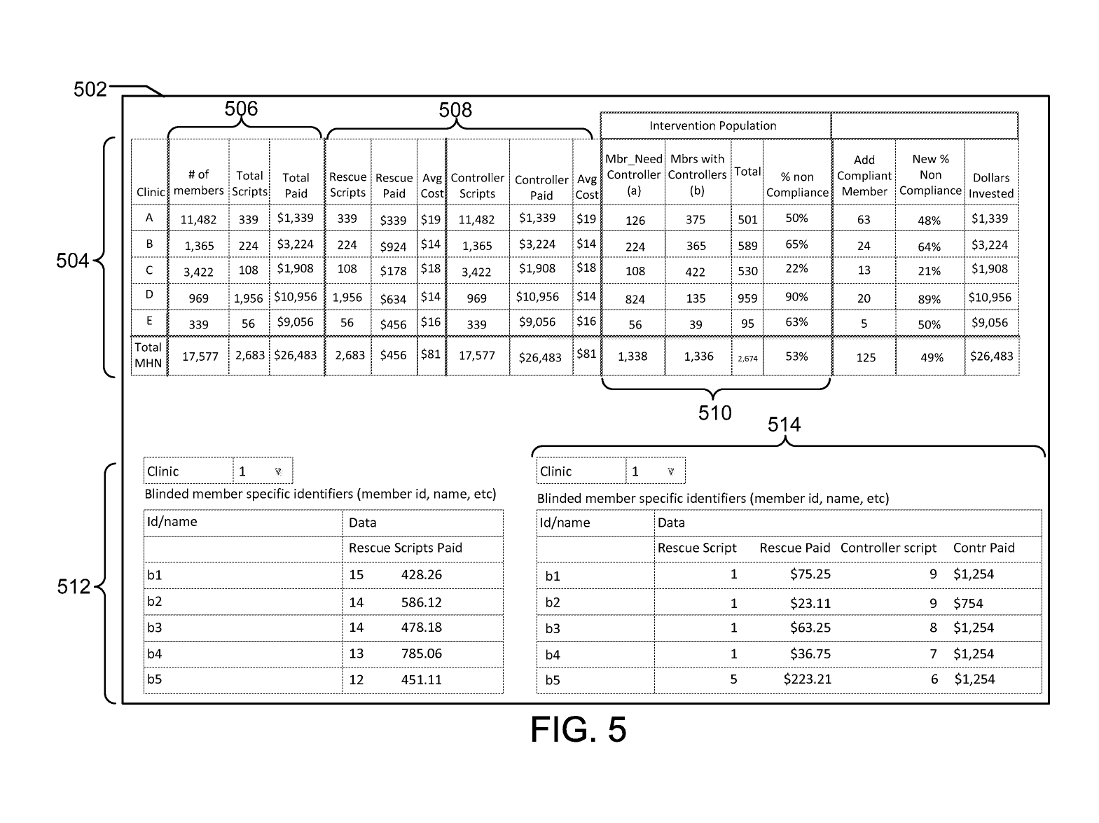

FIG. 5 illustrates another report displayed on a graphical user interface according to some embodiments. Report 502 may include an area 504 that details information or metrics across a number of clinics. As an example, area 504 may include data 506 of a number of patients or “members” of each clinic, a total number of prescriptions (or “scripts”) filled by patients at each clinic, total amount paid for prescriptions, etc. As another example, area 504 may include data 508 of a number of “rescue scripts” filled to alleviate symptoms of their condition due to non-compliance, an amount of money paid to fill the rescue scripts, the average cost of these rescue scripts, etc. As yet another example, area 504 may include data 510 of a number of “controller scripts” filled to alleviate symptoms of their chronic conditions, an amount of money paid to fill the controller scripts, the average cost of these rescue scripts, etc.

In some embodiments, report 502 may include area 512 identifying patients with a number of “rescue scripts” over a certain threshold. the amount spent on their controller medication, etc. In other embodiments, report 502 may include area 514 of a number of “rescue scripts” for patients of a clinic, the amount spent on their rescue medication, number of “controller scripts” for patients of a clinic, the amount spent on their controller medication, the amount spent on their controller medication, the total prescription amount, etc. In some embodiments, report 502 may be included as part of a utilization report of a clinic. A clinic administrator may use report 502 to analyze the performance at the clinic and possibly adjust the operation of the clinic. As an example, a clinic administrator may use report 502 to perform a benchmark performance analysis of the clinic providing long-term care of patients with chronic conditions. In some embodiments, the information coordination system may identify the assigned clinic of each patient that spends more than a given threshold on rescue scripts and transmit report 502 to the assigned clinics through electronic mail.

In one instance, report 502 may include information and metrics in regard to a particular condition, for example asthma. As an example, the clinic administrator may benchmark efforts to reduce non-compliance by patients to taking their controller medication for asthma. Report 502 may provide data from a number of similar clinics (e.g., same size, patients under treatment, location, etc.) that includes a number of metrics of interest. Furthermore, report 502 may include data documenting the number of patients of the clinic who need controller medication, the number of patients taking their controller medication, the percentage of patients not taking their controller medication, etc. Report 502 may further include information of patient activity that occurred since the previous version of utilization spreadsheet 500, for example a number of patients who have started using controller medication since the previous version of utilization spreadsheet 500, an updated percentage of patients still not taking their controller medication that includes the more recent activity, an amount of money invested since the previous version of the spreadsheet to reduce non-compliance, etc. As an example, the clinic administrator may identify specific patients who have a number of rescue prescriptions filled for asthma and try to perform outreach to try to identify the specific reasons for the non-compliance, for example not being able to afford the controller medication, not remembering to take the controller medication, not having the time to fill the prescription for the controller medication, etc. The clinic administrator may identify solutions to help bring the patient into compliance, for example identifying possible generic medication to reduce medication costs, automated reminders for patients to take the controller medication, getting home delivery of the controller medication, etc.

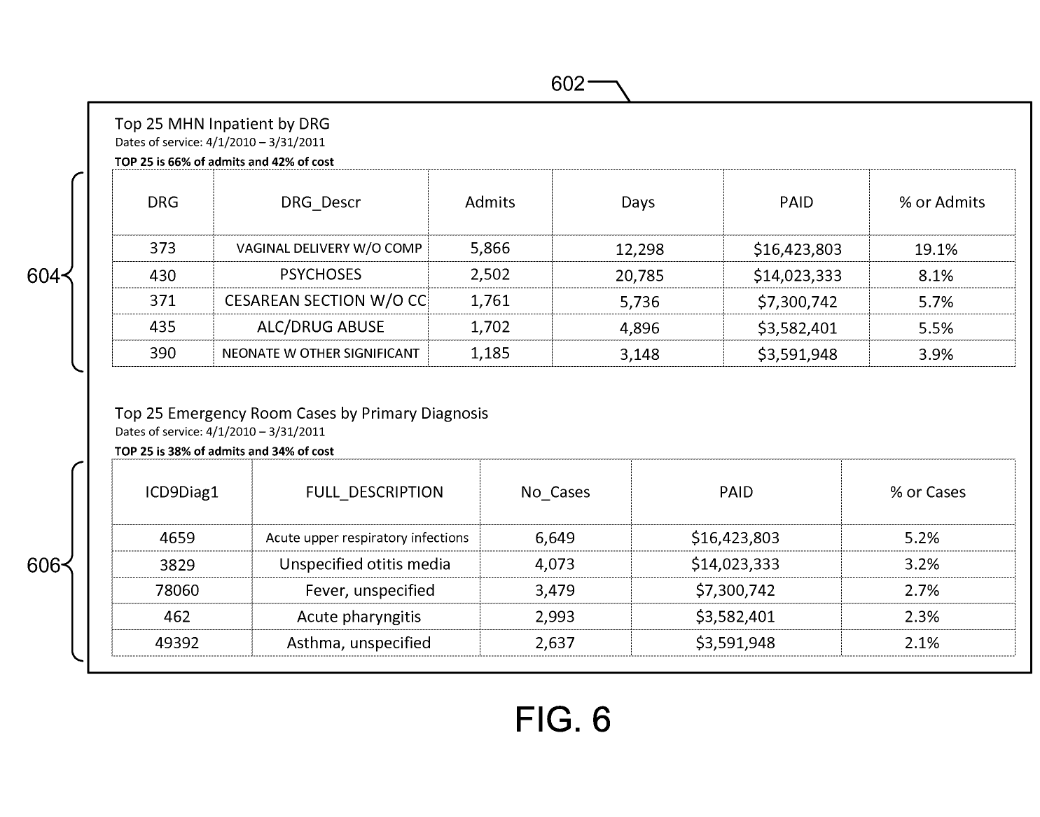

FIG. 6 illustrates another report displayed on a graphical user interface according to some embodiments. Report 602 may include an area 604 that may include information and metrics in regard to the most diagnosed patient conditions, for example substance abuse, psychological disorders, etc. As an example, area 604 may provide information regarding patients treated at the hospital by diagnoses according to diagnosis-related groups (DRG), for example, substance abuse, psychoses, etc. For example, area 604 may include the number of admissions, days patients stayed receiving treatment, amount of money paid, percentage of overall admissions, etc. for each DRG. Furthermore, area 604 may include metrics such as a percentage of the overall patient admissions include the medical conditions with a number of diagnoses above a certain threshold, the percentage of the overall patient costs are determined by the diagnosed conditions, etc. In addition, area 604 may include a DRG code corresponding to different DRGs.

In some embodiments, report 602 may an area 606 that may include data for a particular department of the hospital, for example the ED. As an example, area 604 may provide information regarding patients treated at the hospital by diagnoses according to ICD codes, for example, acute uris, fever, asthma, etc. For example, area 604 may include the number of cases, amount of money paid, percentage of each diagnosis to the overall number of diagnosed cases, etc. for each ICD code. Furthermore, area 604 may include metrics such as a percentage of the overall patient admissions to the department and may include the top diagnosed conditions, the percentage of the overall patient costs of the department are determined by the top diagnosed conditions, etc. In addition, area 604 may include an ICD code corresponding to different diagnoses.

In some embodiments, report 602 may be included as part of a utilization report of a hospital. A hospital administrator may use report 602 to analyze the performance at the hospital and possibly adjust the operation of one or more departments of the hospital. As an example, a hospital administrator may be interested in benchmarking the performance of the different departments of the hospital relative to each other and may use report 602 as part of the analysis.

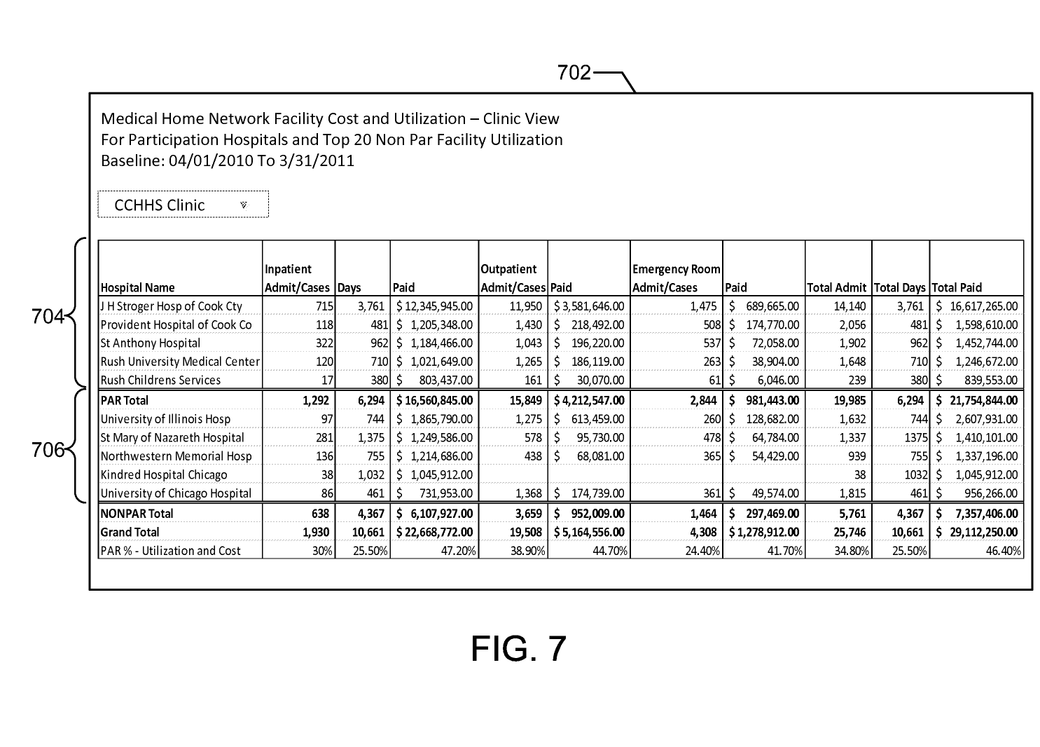

FIG. 7 illustrates another report displayed on a graphical user interface according to some embodiments. Report 702 may include data benchmarking the performance of a hospital relative to other hospitals. As an example, the hospital administrator may be interested in benchmarking the effectiveness of a program based on data of participating or non-participating hospitals. In one instance, report 702 may include information and metrics in regard to the different types of patient admissions, for example inpatient, outpatient, ED, etc. As an example, report 702 may provide information regarding patients treated at each benchmarked hospital according to participation or non-participation in a particular program (e.g., patient outreach), in areas 704 and 706, respectively, Area 704 may include the number of admissions, days patients received treatment, amount of money paid, etc. for each type of admission (e.g., inpatient, outpatient, ED, etc.) for hospitals participating in a patient outreach program. Area 706 may include the number of admissions, days patients received treatment, amount of money paid, etc. for each type of admission (e.g., inpatient, outpatient, ED, etc.) for hospitals not participating in a patient outreach program.

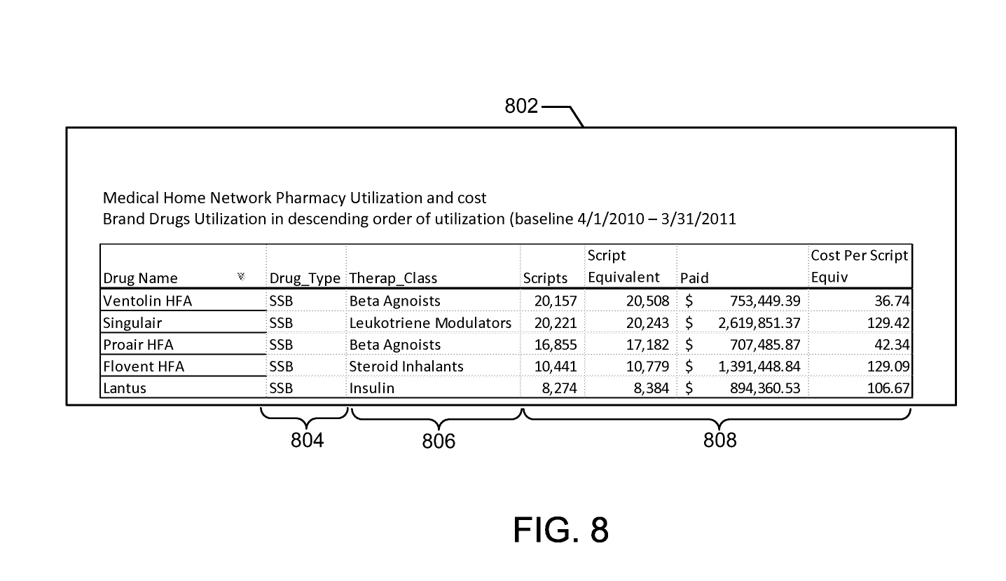

FIG. 8 illustrates another report displayed on a graphical user interface according to some embodiments. In some embodiments, report 802 may include information and metrics in regard to the drug type 804 of the medication, therapeutic class of the medication 806. In addition report 802 may include area 808 that may include number of scripts (or prescriptions) filled, number of script equivalents, total amount paid per medication, cost per script equivalents, etc. A script equivalent calculated as a script (e.g., value equal to 1) for prescriptions that were prescribed with an amount of medication for less than 30 days, otherwise it is calculated by dividing the number of days medication is used by 30 days. As an example, report 802 may sort the data in accordance to the different types of medication, drug type, therapeutic class of the medication, number of scripts (or prescriptions), number of script equivalents, total amount paid per medication, cost per script equivalents, etc.

As an example, a computing system of the information coordination system an administrator at the CMS may look to reduce the prescription costs of Medicare patients. As an example, the information coordination system may provide a visual indication (e.g., highlighting, underlining, etc.) on report 802 highlighting the information associated with the medications that are reimbursed at a cost is above a given threshold. As another example, the information coordination system may e-mail a list of the medications that are prescribed a number of times that is above a given threshold. In one instance, the Medicare administrator may decide to encourage physicians with Medicare patients who prescribe the identified medications to switch to prescribing generic equivalent instead. In another instance, the Medicare administrator may decide to change the Medicare formulary to discontinue reimbursing prescriptions of the identified medications.

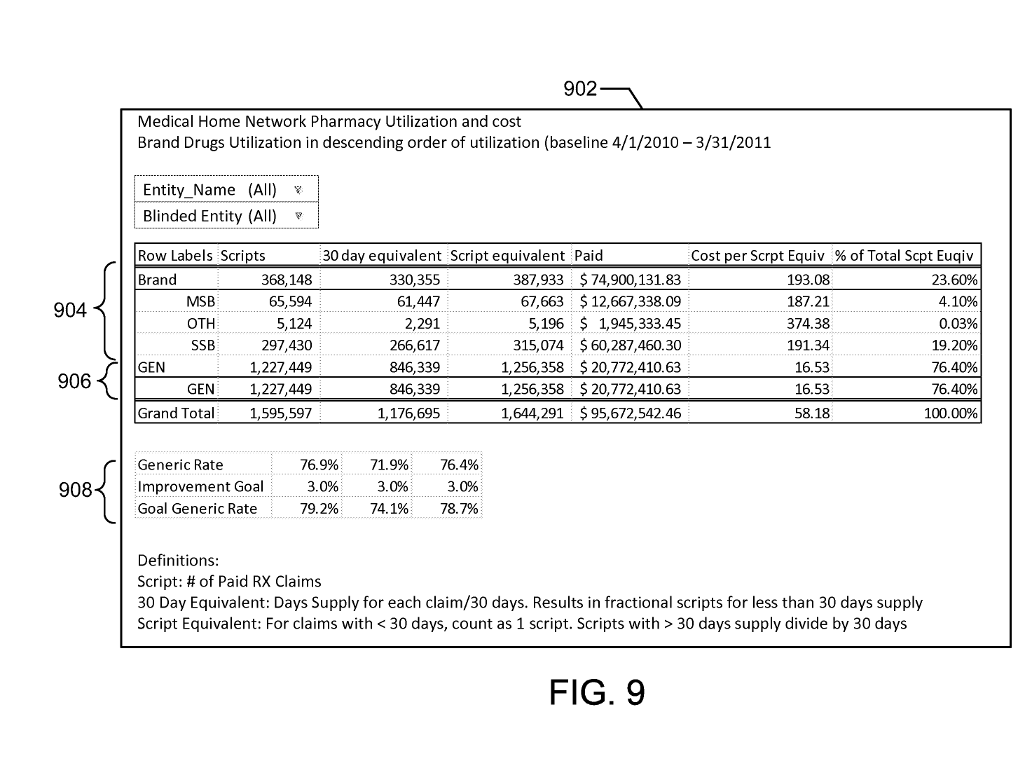

FIG. 9 illustrates another report displayed on a graphical user interface according to some embodiments. In one instance, report 902 may include information and metrics in regard drug type, therapeutic class of the medication, number of scripts (or prescriptions), number of script equivalents, total amount paid per medication, cost per script equivalents, etc. for brand-name medications compared to their generic equivalent. As an example, area 904 of report 902 may include the information and metrics described above for types of branded medications (e.g., multi-source brand-name (MSB), single-source brand-name (SSB), etc.), As another example, area 906 of report 902 may include the information and metrics described above for the generic equivalent. In some embodiments, the data of report 902 may be sorted in accordance to the number of scripts (or prescriptions), number of script equivalents, 30 day equivalent, total amount paid per medication, cost per script equivalents, etc. The 30 day equivalent is calculated as the number of days of the prescription divided by 30. Area 906 may include a percentage of the total number of prescriptions that the generic medication is filled, a target percentage improvement from a previous time period, a target percentage rate of generic medication use, etc.

FIGS. 10A-F illustrate operating environments according to some embodiments. It is appreciated that operating environment 1000 may generate any of the reports, as described in FIGS. 1-9. Operating environment 1000 may include a number of servers, e.g., 1002, in communication with servers 1004 of an information coordination system. Servers 1002 correspond to servers at hospitals, servers 1004 to servers of an information coordination system, servers 1006 to CMS servers, servers 1008 to clinic servers, servers 1010 to health information exchange servers, and servers 1012 to patient servers. It is appreciated that the operating environment 1000 may also include health insurance companies, payors, etc., (not shown). Patients may receive healthcare services from one or more of the hospitals, CMS, and/or clinics. Furthermore, over a lifetime, individual patients may have, for example, used multiple hospitals, health information exchanges, or clinics. For example, patients may have used multiple clinics if they have moved or changed their health insurance provider. As described herein, servers 1004 of information coordination system aggregate data stored by servers, e.g., 1002, of the different healthcare providers, e.g., disparate healthcare entities, regarding a patient. It is appreciated that the aggregated patient data may include but is not limited to historical prescription and medical claims data, patient diagnosis, patient diseases, physical examination, etc. In some embodiments, aggregated patient information may include “real-time alerts” associated with patient hospital activity, e.g., patient visiting a hospital complaining about a headache, patient being admitted to a hospital, patient visiting a hospital complaining about chest pains and lab works ordered for the chest pain, etc.

The aggregated information accessed by servers 1004 of the information coordination system may be used to generate a report (e.g. one of the reports described in the previous figures) for appropriate healthcare provider, e.g., assigned clinic. The report may be used by the appropriate healthcare provider, e.g., assigned clinic, to better understand the medical situation of a patient and to tailor medical care and treatment to improve patient care, e.g., by setting up a follow up visit, by reminding the patient to pick up medication, etc. In other words, portions of the aggregated data may be used by servers 1004 of the information coordination system to generate a relevant report and may be provided to the relevant healthcare providers, e.g., assigned clinic, to coordinate healthcare treatment.

Hospitals, CMS, clinics, and health information exchange, may each include multiple entities or be a combination of multiple types of entities (e.g., hospitals or clinics). Hospitals are healthcare entities whose services may include after-hours and/or specialized treatment for a variety of patient ailments or treatment for more serious patient ailments requiring immediate attention. As an example, the ED of hospitals may provide treatment to patients for conditions that require immediate attention. In some embodiments, servers 1002 of hospitals may provide near real-time data on patient activities to server 1004 of information coordination system. For example hospital admission, discharge, transfer data (e.g., from the ED to internal medicine), patient visiting a hospital complaining about a headache, patient being admitted to a hospital, patient visiting a hospital complaining about chest pains and lab works ordered for the chest pain, medication ordered, etc., may be received by information coordination system 1004 in near real-time.

As described above, near real-time data refers to reception of data from a computing system of a healthcare entity to information coordination system within a short period of time (e.g., an hour or a day) compared to adjudicated medical claim data provided by servers 1006 of CMS or servers 1010 of health information exchange, which is in the order of weeks or months old. As an example, near real-time data from servers 1002 of hospitals may be received within a range of approximately 0.5 hours to 24 hours of patient activity. As another example, near real-time data from servers 1008 of clinics may be received within a range of 1 day to 2 days of a change in a care plan of patients being entered into a computing system of clinics. As another example, patient data may further include prescription data. In other embodiments, servers 1002 of hospitals may provide non-claim based data, for example diagnosis (DX) summaries or ED notes in the form of a patient's electronic health record (EHR) is a digital version of the patient's paper hospital chart. As another example patient data may include data collected via remote monitoring devices and/or surveys administered in the field.

Clinics are healthcare entities, for example clinics, that provide out-patient preventative or follow-up treatment to patients. For example, healthcare professionals at clinics may perform yearly laboratory (“lab”) work and check-up with patients to determine the general health status and provide any necessary preventative treatment, for example design long-care plans or diagnose chronic problems (e.g., hypertension). In some embodiments, patients that sign up for Medicare or Medicaid may be automatically assigned to one of the clinics, such that data of patients may be provided to servers 1004 of information coordination system by servers 1008 of clinics that are a part of operating environment 1000. In addition, clinics may be responsible for follow-up care of patients after a hospital stay or visit to an ED. Furthermore, within each clinics are PCPs whom the patients are assigned for overall care, servicing, or rendering providers of the actual services, prescribing physicians, as well as other associated type services, e.g., lab, radiology, etc.

CMS administers public health insurance plans (e.g., Medicare), health information exchange, and private (e.g., CIGNA) health insurance plans by processing claims and distributing reimbursements for treatment provided by one or more healthcare entities, for example hospitals or clinics. CMS is a Federal agency that administers Medicare and, in conjunction with states, Medicaid. In some embodiments, CMS or health information exchange may provide a patient's insurance eligibility, medical prescription (Rx), or insurance claim data to servers 1004 of information coordination system. In some embodiments, patients signing up for Medicaid or Medicare creates a patient record at servers 1006 of CMS. In other embodiments, patients signing up for private healthcare insurance through an insurance exchange create a patient record at servers 1010 of health information exchange. The patient records stored by servers 1006 of CMS or servers 1010 of health information exchange may include health insurance eligibility data or claim information that is accessible by servers 1004 of information coordination system.

As described above, servers, e.g., 1002, of the healthcare entities may be communicatively coupled to servers 1004 information coordination system through network 1014. Network 1014 may include more than one network (e.g., intranets, the Internet, local area networks (LANs), wide area networks (WANs), etc.) and may be a combination of one or more networks including the Internet or web-based portals. While the disparate healthcare entities, for example servers 1002 of hospitals or servers 1008 of clinics, may be communicatively coupled to servers 1004 of information coordination system, servers, e.g., 1002 and 1008, of the healthcare entities are not in communication with each other. In other words, data of patients are stored in isolated systems or silos maintained by servers, e.g., 1002, of the different healthcare entities. In some embodiments, data exchange between servers 1004 of information coordination system and servers, e.g., 1002, of the disparate healthcare entities, for example hospitals or clinics, through a web-based connector portal is provided. In other embodiments, data exchange between servers 1004 of information coordination system and the disparate healthcare entities may be performed through paper output, text, email, phone call, etc.

As illustrated in the FIGS. 10B-F, servers 1002 of hospitals may correspond to servers 1002A-N of multiple hospitals and servers 1008 of clinics may correspond to servers 1008A-I of multiple clinics. Furthermore, servers 1002A-N of each hospital and servers 1008A-I of each clinic may be communicatively coupled to servers 1004 of information coordination system. As illustrated in FIG. 10B, a patient may be assigned to clinic (server 1008B) for primary care that includes treatment of hypertension using a particular medication. The patient may be admitted to the ED of hospital (server 1002B) to be treated for injuries caused by a fainting episode. After a series of test have been run, the attending physician may change the medication taken by the patient to adjust the blood pressure of the patient. The patient activity may be received by server 1004 of information coordination system in “real-time” as an ED note. Server 1004 of information coordination system may determine the patient is assigned to clinic (server 1008B) and transmit an alert or notification to clinic (server 1008B) to make the primary care coordinator aware of the change in medication, as illustrated in FIG. 10B.

As illustrated in FIG. 10C, a patient may be assigned to clinic (server 1008B) for primary care, but that does not provide any vaccinations. The patient may be of an age where a herpes zoster or shingles vaccination is recommended and is not able to get through the assigned clinic (server 1008B). Instead, that patient may go to clinic (server 1008A) that performs vaccinations to get the shingles vaccination. Information that the patient received the shingles vaccination is generated at clinic (server 1008A) and is received by server 1004 of information coordination system. Server 1004 of information coordination system may transmit a notification to the primary care coordinator of clinic (sever 1008B) that the patient has been immunized for shingles and the primary care coordinator of the patient may update the patient's medical record accordingly.

As illustrated in FIG. 10D, a patient may go to the ED of hospital (server 1002B) to be treated for chest pains and arrhythmia After running a series of diagnostic tests, the physicians may diagnosis the patient diagnosis as suffering from CHF and prescribe the patient a regime of nitroglycerin tablets to manage the condition. Information related to the diagnosis and treatment of the patient is received by server 1004 information coordination system. Server 1004 of information coordination system may determine that the patient has not been assigned to a clinic and based on factors such as location relative to the patient or physician availability, the patient may be assigned to clinic (server 1008B) to receive follow-up care. Server 1004 of information coordination system may then transmit a clinic referral form referring the patient for follow-up care at clinic (server 1008B) and the patient information is transmitted to clinic (server 1008B).

As illustrated in FIG. 10E, a patient may be assigned to clinic (server 1008B), where clinic (server 1008B) has been overseeing the long-term care of the patient, including performing annual check-ups and supervision medications for any chronic conditions. Server 1004 of information coordination system may receive the patient information from clinic (server 1008B) that includes the long-term care plans of the patient. The patient may go to the maternity department of hospital (server 1002B) to perform a delivery. Information related to admission of the patient to the maternity department of hospital (server 1002B) is received by server 1004 of information coordination system. Server 1004 of information coordination system may send the long-term care information originally stored at clinic (server 1008B) to hospital (server 1002B), such that the physicians for the maternity department are able to determine if the any chronic conditions or medications being taken by the patient warrant special attention.

As illustrated in FIG. 10F, a patient may visit the ED of hospital (server 1002A) for treatment for head trauma from an automobile accident. Hospital (server 1002A) may be the closest to the scene of the accident, but due to its size may lack some diagnostic equipment present at larger hospitals. The physicians attending the patient at hospital (server 1002A) may be unable to properly extent of the head trauma of the patient due to not having the proper equipment. For this reason, the patient may be transferred to another hospital (server 1002B) that is better equipped to evaluate the patient. Server 1004 of information coordination system may receive the patient information from hospital (server 1002A) that includes any preliminary diagnosis and medical procedures performed at the ED of hospital (server 1002A), as well as the information that the patient is being transferred. Server 1004 of information coordination system may send the patient information received from hospital (server 1002A) and send the patient information to the neurological department of hospital (server 1002B), such that the neurologists at hospital (server 1002B) have the most current medical information of the patient.

FIG. 11 illustrates a data flow diagram according to some embodiments. Information coordination system 1104 may be configured to receive from hospitals 1102, CMS 1106, clinics 1108, health-information exchange 1110, and patients 1112. As described above, information coordination system 1104 is configured to aggregate data from the disparate healthcare entities and facilitate the timely exchange of information between healthcare entities to improve healthcare quality with higher efficiency. In some embodiments, information coordination system 1104 may include a data store module 1120, data analytics module 1122, data representation module 1124, and messaging module 1126. Data store module 1120, data analytics module 1122, data representation module 1124, and messaging module 1126 may be executed on one or more computing systems (e.g., virtual or physical computing systems).

Data store module 1120 may be stored in a data warehouse. In some embodiments, data from hospitals 1102, CMS 1106, clinics 1108, health-information exchange 1110, and patients 1112 may be stored in data store module 1120 as part of one or more databases. The stored data may be stored hierarchically where each entry may have one or more sub-entries. For example, entries in the data structure may correspond to the individual patients 1112 (e.g., patient's name) and the sub-entries may be the data of the individual patients 1112, e.g., patient diagnosis, age, gender, medication, assigned clinic, etc. The data structure may include data of patients obtained from hospitals 1102, CMS 1106, clinics 1108, health-information exchange 1110, and the patients themselves. In some embodiments, the data structure of patients 1112 may be organized in a hierarchy of clinics 1108 and hospitals 1102 based on the particulars of each patient 1112 (e.g., medical treatments, type of medical coverage, etc.). In some embodiments, data store module 1120 may be implemented using database software as a service (dbSaaS).

Clinics 1108 may send data that includes information of activity of patients after a hospital visit, patient care plans, or care management notes. In one instance, a patient diagnosed with diabetes may have a care plan that calls for the patient to be on a restricted diet and have daily insulin injections. The data of the patient's care plan may be sent from clinics 1108 to data store module 1120. CMS 1106 and health information exchange 1110 may send data for storage on data store module 1120 and may indicate a patient's insurance eligibility, medical claim information submitted by healthcare entities, prescription information, etc. As an example, hospitals 1102 may submit a claim to be reimbursed for procedures performed on patients 1112. The claim may include information such as healthcare common procedure code system (HCPCS) that identify specific health interventions that were performed by medical professionals during the patient visit to hospitals 1102. In some embodiments, information coordination system 1104 may access the claim information stored on CMS 1106 or health information exchange 1110 to obtain information on visits to hospitals 1102. In some embodiments, data from the healthcare entities may be transmitted to data store module 1120 of information coordination system 1104 over a secure (e.g., encrypted or virtual-private) network.

In some instances, data from the healthcare entities (e.g., hospitals 1102 or clinics 1108) may be “pulled” by information coordination system 1104, where information coordination system 1104 initiates the transfer of data, or “pushed” to information coordination system 1104, where the healthcare entities (e.g., hospitals 1102 or clinics 1108) initiates the transfer of data. For example, hospitals 1102 may send data that indicate that a patient has been admitted, transferred, visited, or discharged from hospital 1102. In one instance, when patients 1112 are admitted to the ED of a hospital, this admission is entered into a computing system of hospitals 1102 and data of the admission may be sent to data store module 1120 in near real-time (e.g., within 24 hours of the data being entered). In another instance, data may be sent from hospitals 1102 to data store module 1120 indicating that a patient has been discharged from hospitals 1102 when the discharge paperwork of the patient is processed and entered into the computing system of hospitals 1102. As another example, a doctor may summarize the diagnosis and treatment of the patient by filling out an EHR and the information of the EHR may be sent to data store module 1120.

In some embodiments, patients 1112 may send health data to be stored on data store module 1120 and may reflect symptoms being experienced by the patient, biometrics, or health questions the patient may have. As an example, a remote home monitoring program may wirelessly connect one or more medical diagnostic devices that transcribe patients 1112 medical readings in an encrypted fashion and transmit the readings to information coordination system 1104 over a secure network. The diagnostic devices may include blood pressure cuffs or weight scales equipped with a suitable wireless, e.g., BLUETOOTH, technology. Furthermore, the diagnostic devices may transmit diagnosis readings to a cellular pod that then encrypts the readings and relays them to information coordination system 1104.

Although this disclosure describes generation of a utilization report using example types of data from example healthcare entities, this disclosure contemplates generating reports taking any suitable data from any suitable entities. In some embodiments, data analytics module 1122 may analyze data of patients 1112 stored in data store module 1120 in response to receiving activity of patients 1112, e.g., a patient being transferred from the ED to the intensive care ward of a hospital. For example, data analytics module 1122 may determine information regarding a patient visiting a hospital has been updated in data store module 1120 (e.g., through an updated time stamp). Data analytics module 1122 may access information regarding the patient stored in data module 1120 that pertains to long-term care plans or medications prescribed. As another example, data analytics module 1122 may access information regarding the patient pertaining to medical procedures being performed at the hospital in response to data analytics module 1122 determining the patient is visiting the hospital. In some embodiments, data of patients 1112 may be used to generate messages or notifications of the status of patients 1112. As an example, data analytics module 1122 may generate a message in response to determining data of a patient has been updated. For example, the messages may include information of the hospital treating a patient, a description of medical treatment performed on the patient at hospital, the current status of the patient, etc. accessed by data analytics module 1122. As another example, the report generated by data analytics module 1122 may be transmitted to the assigned clinic in order to improve patient care (e.g., by setting up a follow up appointment, by reminding the patient to pick up medication, etc.).

Data analytics module 1122 may process historical patient data, CMS data, or clinic data to provide useful data for utilization benchmarking. As an example, hospitals 1102 may file claims for procedures or diagnoses of a patient that may be described using ICD codes. In some embodiments, data analytics module 1122 may group the ICD codes received from CMS 1106 or health information exchanges 1110 into super-categories or categories that encompass several ICD codes or medical procedures. As an example, based on an ICD-9 code, data analytics module 1122 may determine a patient had been treated at the ED of hospitals 1102. Furthermore, data from CMS 1106 or health information exchange 1110 may include the financial data associated with each ICD code, for example the amount of money reimbursed to a hospital or clinic for a given procedure. In other embodiments, data analytics module 1122 may modify the utilization data based on the non-claim based or unadjudicated data of patients 1112, for example near real-time activity from hospitals 1102, diagnosis summaries, or ED notes from hospitals 1102.

In some embodiments, data analytics module 1122 may generate a report of healthcare utilization based on costs of a number of procedures or based on the number of procedures that are performed. As an example, data analytics module 1122 may access information regarding a patient stored in data storage module 1120, for example ICD codes, and based on groupings of procedures or conditions described above, determine a number of times a condition (e.g., fever, asthma, etc.) has been diagnosed during a given period of time at a hospital. As an example, data analytics module 1122 may identify the ICD codes associated with CHF and determine the number of times CHF was diagnosed at the hospital. As another example, data analytics module 1122 may identify the ICD codes associated with a Caesarian delivery and determine the number of times Caesarian deliveries were performed at the hospital. Data analytics module 1122 may rank and sort the report based on the number of times a particular diagnoses occurred in a given period of time for a given healthcare entity (e.g. hospital). Furthermore, data analytics module 1122 may determine a total cost or average cost associated with each condition, a quarter or date each condition was diagnosed, etc.

In some embodiments, data analytics module 1122 may determine the follow-up activity of a patient treated at a hospital. As an example, data analytics module 1122 may access information regarding medical treatments of the patient (e.g., ICD codes) after leaving a hospital. Data analytics module 1122 may identify and associate treatment performed after leaving the hospital with the medical condition that required the hospital visit (e.g., through ICD grouping). Based on the identified treatment, data analytics module 1122 may determine which diagnosed conditions or medical treatments performed at the hospital have the highest follow-up rates. As another example, data analytics module 1122 may determine based on the accessed data if the patient returned to a hospital to be treated for the same condition that prompted the original hospital visit and determine a period of time that elapsed since the initial hospital visit. Accordingly, the data analytics module 1122 calculates the readmission rate for different conditions and procedures.

In some embodiments, data analytic module 1122 may calculate a comparison or benchmark of costs of procedures and number of procedures performed by a healthcare entity (e.g., hospital) relative to other healthcare entities. As an example, data analytic module 1122 may compare a number of ED visits over a period of time or the number of procedures performed or conditions diagnosed (e.g., through ICD information and grouping) as compared to a baseline or target value. In some embodiments, the data may be obtained from patient data from hospitals 1112 or clinics 1108. In other words, the utilization of each hospital or clinic may be compared to all the hospitals 1112 or clinics 1108 that provide information to information coordination system 1104. As an example, data analytics module 1122 may calculate one or more benchmarks or metrics based on information stored in data storage module 1120. For example, data analytics module 1122 may determine a number of times a condition (e.g., CHF, diabetes, etc.) has been diagnosed at each hospital and calculate an average number of times each diagnoses was made (e.g., total times a condition diagnosed divided by the number of hospitals 1112). As another example, data analytics module 1122 may calculate a benchmark indicative of a number of times a condition has been treated or diagnosed previously for a given period of time. For example, data analytics module 1122 may determine a hospital treated 47 asthma cases on average per quarter based on information stored on data storage module 1120 corresponding to the previous five quarters.

The utilization of each hospital or clinic may be compared to random sampling of the hospitals 1112 or clinics 1108 that provide information to information coordination system 1104. In some embodiments, the utilization of each hospital or clinic may be compared to sampling of the hospitals 1112 or clinics 1108 where the data is weighted or normalized based on the size (e.g., number of beds) of each hospital or clinic. As an example, data analytics module 1122 may access information of each hospital providing information of the size and normalize the calculated benchmarks by the ratio of the number of physicians, beds, budgets, etc. In other embodiments, the targets or benchmarks may be relative to similar healthcare entities. As an example, data analytics module 1122 may access hospital information (e.g., size, geographic location, etc.) and filter out information from hospitals outside of a given range of the size and/or geographic location of the hospital being benchmarked. In yet other embodiments, the utilization of each hospital or clinic may be based on the demographics of the patients (e.g., gender, age, geographic location, etc.). As an example, data analytics module 1122 may access demographic information regarding the patients of interest (e.g., visited a hospital for asthma conditions) and calculate a number of procedures (e.g., child deliveries) were performed for female patients between the ages of 35-40 for each hospital as a benchmark.

In some embodiments, the software suite SAS Stats that may be used to execute one or more procedures to analyze the data of patients 1112 and generate the utilization report. In some embodiments, data analytics module 1122 may implement data mining of the stored data using HADOOP may be used to analyze the data of hospitals 1102 to compute an average length of stay for each medical condition, the amount of cost associated with treating each medical condition, the mortality rate associated with each medical condition, reimbursement rates of different type of medical procedures, etc. In some embodiments, results from different clinics 1108 or hospitals 1102 may be normalized based on the number of beds, number of patients, number of procedures, patient demographics, etc. For CMS 1106 or health information exchange 1110, the calculation may be determining a period of time to adjudicate a medical claim once it is received by either hospitals 1102 or clinics 1108 or determining a period of time to reimburse hospitals 1102 or clinics 1108 once a claim has been received.

In some embodiments, messaging module 1126 may include one or more messaging systems or platforms which may include a database (e.g., messaging, SQL, or other database), SMS, multimedia messaging service (MMS), instant messaging services, Extensible Markup Language (XML) based messaging service (e.g., for communication with a Fusion center), JAVASCRIPT Object Notation (JSON) messaging service, place a call, send a fax, etc. As an example, a report of patients 1112 with long-term care plan information and/or with relevant information to improve patient care may be sent by messaging module 1126 as an e-mail message to the physicians caring for a patient having a stay at hospitals 1102. As another example, messaging module may send a SMS message informing a clinical or primary care coordinator that a patient has been admitted to the ED of a hospital. Accordingly, appropriate actions may be taken in order to ensure the physicians, either at the hospital or clinic, treating the patient has the most complete picture of the health situation of the patient. In some embodiments, a hyperlink to the report generated by data analytics module 1122 may be sent by e-mail to through electronic mail (e-mail). In other embodiments, the report may be attached to the e-mail message.

Data representation module 1124 may be operable to render a GUI displaying relevant information or a portion of the aggregated data of patients 1112 based on the processed information from the data analytics module 1122 as a utilization report described above. In some embodiments, data representation module 1124 may allow a hospital or clinic administrator to display patient's history and patient's most recent activities, e.g., hospital visit, diagnosis, etc. The healthcare professional may have the opportunity to inspect the various data that the data analytics module 1122 has collected (e.g. long-term care plans, hospitalization history, medical readings, etc.) that triggered the alert. In some embodiments, data representation module 1124 may send a report that may include benchmark data, medical alerts, or activity of patients 1112 to a messaging system (e.g., messaging system 1126) for distribution (e.g., hospitals 1112, clinics 1108, etc.).

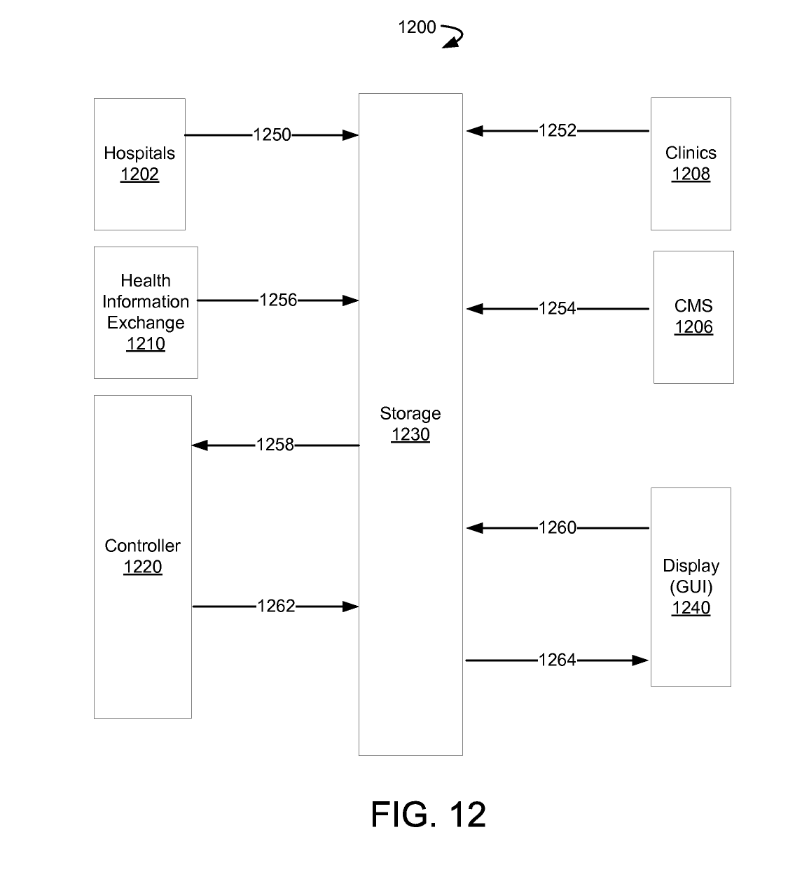

FIG. 12 illustrates data interactions within an information coordination system according to some embodiments. “Longitudal data” may be separately stored by a number of healthcare entities, transmitted to the information coordination system, and aggregated in a storage 1230. A hospital administrator may want to benchmark the performance of their facility in areas of utilization of various departments, for example the ED of the hospital, or determine the effectiveness of treatment based on the readmission rate of patients treated at the hospital. The information coordination system may access the historical data stored on storage 1230 that covers a time period of interest and mine the data to provide the hospital administrator a number of snapshots of the hospital performance compared to benchmarks or other hospitals. As described above, the snapshots may be combined into a utilization report that may be displayed on, for example, a GUI for the hospital administrator to view.

In some embodiments, storage 1230 of the information coordination system may receive data from hospitals 1202, CMS 1206, health information exchange 1210, and clinics 1208. Storage 1230 may store data that includes data 1250 generated by hospitals, data 1252 generated clinics 1208, data 1254 generated by CMS 1206, or data 1256 generated by health information exchange 1210. In some embodiments, storage 1230 may store data in a particular data structure, database format, hierarchical format, etc. For example, a hierarchical format may sort data by hospital name first and everything else at the bottom, or clinic first and the rest below it, etc. As an example, storage 1230 may include data store module 220. In some embodiments, controller 1220 may automatically and directly access longitudinal patient data locally stored in storage devices (not shown) of hospitals 1202, CMS 1206, health information exchange 1210, or clinics 1208 through a web-based portal.

In some embodiments, storage 1230 may receive near real-time activity of patients, DX summaries, or ED notes from hospitals 1202. As described above, hospitals 1202 may send data 1250 that indicates that patients have been admitted, transferred, visited, or discharged from hospital 1202. In one instance, when patients are discharged from a hospital, discharge information is entered into a computing system of hospitals 1202 and data 1250 of each admission may be received by storage 1230 in “real-time”. In another instance, a doctor treating patients at hospitals 1202 may summarize the diagnosis and treatment of the patients by filling out an EHR and the information of the EHR 1250 may be received by controller 1220.

In some embodiments, storage 1230 may receive information 1252 of activity of patients after a hospital visit, patient care plans, or care management notes from clinics 1208. In one instance, storage 1230 may receive information 1252 that a patient who has asthma has been prescribed an albuterol inhaler. In another instance, storage 1230 may receive information 1252 that a patient has been participating in follow-up visits with a physician at clinics 1208 for their asthma condition and the data detailing the current treatment of the asthma condition. However, it is appreciated that according to some embodiments patient's participation is optional and that clinics 1208 may be notified regardless of patient's permission to participate, provided that the hospitals 302 and/or clinics 308 are eligible to provide service.

In some embodiments, storage 1230 may store data 1254 from CMS 1206, health information exchanges, patients, etc. As an example, storage 1230 may store lab data (e.g., lipid, glucose, etc.), prescription (e.g., medication), or secure messaging information of patients from health information exchanges 1210. For instance, a pharmacy may submit a claim with the CMS after filling an albuterol inhaler prescription for a patient and that data may be stored in storage 1230. In another instance, hospitals 1202 may file claims with CMS 1206 or health information exchange 1210 for procedures or diagnoses of a patient that may be described using the international classification of diseases (ICD) codes, e.g., where a common revision of the ICD codes is revision 9 (ICD-9 codes). In other embodiments, storage 1230 may store the non-claim based or unadjudicated data 1250, for example near real-time activity from hospitals 1202, DX summaries, or ED notes from hospitals 1202. In other embodiments, storage 1230 may store the activity 1252 of patients after a hospital visit, patient care plans, or care management notes from clinics 1208.

In some embodiments, controller 1220 may analyze data 1258 of the healthcare entities (e.g., hospitals 1202 or CMS 1206) in order to generate a report for a healthcare entity that may determine various metrics that provide insight into the performance of a hospital or clinic. As an example, controller 1220 may categorize the ICD-9 codes received from CMS 1206 or health information exchanges 1210 into categories of treatment using data mining implemented using data mining software such as SAS Software by SAS or Hadoop by Apache. As an example, based on ICD codes of medical claims submitted to CMS 1206 or health information exchange 1210, controller 1220 may determine a number of patients that been treated at the ED of hospital. As another example, controller 1220 may analyze the ICD codes generated by hospitals 1202 to determine a number of patients who visited the maternity ward of hospitals 1202. In addition, controller 1220 may determine the diagnoses of the conditions being treated by the ED over a period of time. In one instance, the controller 1220 may analyze the ICD codes and determine the number of patients that are treated for urinary tract infections over a period of time. As another example, controller 1220 may analyze the ICD codes of medical insurance claims of clinics 1208 to determine a number of patients performing follow-up visits with their PCP being released from the ED.

As another example, prescription reimbursement information 1254 from CMS 1206 or prescription reimbursement information 1256 from health insurance exchanges 1210 in conjunction with either long-term care or follow-up care data 1252 of clinics 1208 may be used by controller 1220 to determine the number of patients that are taking their medication. In one instance, patients released from the ED after treatment for CHF may be prescribed nitroglycerin tablets and the prescription reimbursement information 1254 from CMS 1206 or the prescription reimbursement information 1256 from health insurance exchanges 1210 may determine if the patient has filled the prescription. In another instance, controller 1220 may determine if a significant percentage of patients assigned to clinic go to another clinic for medical treatment.

In some embodiments, controller 1220 may generate a report in response to receiving a request 1260 sent through a GUI rendered on display 1240. As an example, a primary care coordinator at a clinic may want to benchmark the performance of their facility by examining a utilization report. The primary care coordinator may request 1260 the report through a GUI rendered on display 1240. The generated report may be sent to storage 1230 and fetched 1264 from storage 1230 for rendering on the GUI rendered on display 1240. The report may provide performance data of the respective healthcare entity relative to one or more performance metrics. In some embodiments, the performance metrics may be absolute performance metrics of the respective healthcare entity. In one instance, percentage of readmissions within a period of time (e.g., 30 days) from treatment. In another instance, the performance metric of hospitals 1202 may be the average period of time that a patient stays for a given procedure. In some embodiments, a performance metric may be associated with one or more benchmark. In one instance, the target benchmark associated with hospital remissions should be less than 5% within 30 days of treatment. In another instance, the target benchmark for average patient stays for child delivery may be 2 days or less.

In other embodiments, the performance metric may be relative to the performance of similar healthcare entities. As an example, readmissions for a given procedure might be compared to other healthcare entities that perform the same procedure. In some embodiments, the comparison may be made to an average value or as part of listing of the values of all the entities being compared. In one instance, the average cost of an appendectomy at a hospital may be compared to the average cost of the same procedure as other hospitals. As another example, clinic follow-up rates for a given procedure may be compared to the average follow-up rates of other clinics. In one instance, the average rate of follow-up visits performed by the assigned clinic with their patients treated for an appendectomy may be compared to the rate of follow-up visits performed by other clinics.

In some embodiments, one or more of the relative benchmarks are used in the utilization report. As an example, hospitals may be compared based on the size of the hospital (e.g., number of beds, size of medical staff, annual budget, etc.) or demographics of the patients (e.g., age, gender, insurance status, etc.). As an example, a total number of magnetic resonance imaging (MRI) procedures may be benchmarked for a hospital only using data from large hospitals since only larger hospitals may be able to afford the MRI equipment. The number of child deliveries that is dependent on the number of female patients. In other embodiments, the relative benchmarks may be calculated by controller 1220 using data from all hospitals 1202 or clinics 1208. In other words, the utilization of each hospital or clinic may be compared to all the hospitals 1202 or clinics 1208 that provide information to the information coordination system. As an example, the total number of visits to the ED. As another example, the percentage of readmissions.

In other embodiments, the utilization of each hospital or clinic may be compared to random sampling of the hospitals 1202 or clinics 1208 that provide information to the information coordination system. As an example, the number of tonsillectomies performed by the hospital may be compared to a random sampling of hospitals within a given distance (e.g., 20 miles). In yet other embodiments, the utilization of each hospital or clinic may be compared to sampling of the hospitals 1202 or clinics 1208 where the data is weighted or normalized based on the number of procedures, number of patients, etc. of each hospital or clinic. As an example, the average cost for number of child deliveries.

Hospital or clinic administrators may modify the operation of their hospital or clinic based on the utilization report. As an example, a clinic administrator may determine that patients that need treatment for substance abuse may get treatment at a detox facility rather than the assigned clinic that may not be equipped to treat addition issues. Based on this information, the assigned clinic may decide to set-up an addiction treatment facility on the premises or partner with an addiction treatment facility. As another example, the ED of a hospital may have the capacity to treat a given number of patients a day (e.g., 40 patients), but on average may only treat 20 patients a day. Based on the ED being underutilized, the hospital administrator may reduce the staffing of the ED or close it altogether.

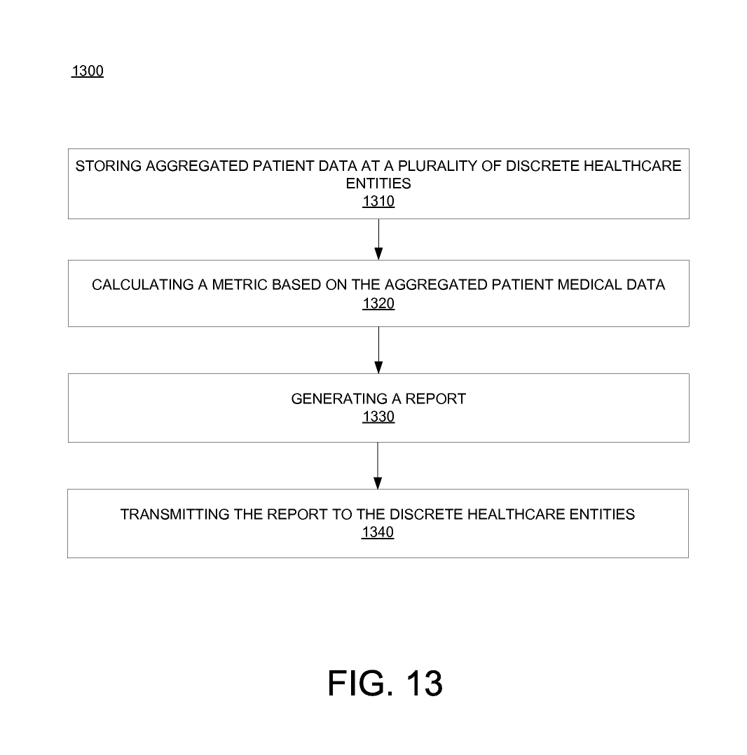

FIG. 13 illustrates a flow chart diagram 1300 for generating a utilization report according to some embodiments. At step 1310, aggregated patient medical data collected from a plurality of discrete healthcare entities is store. In some embodiments, the aggregated patient data is associated with medical activity of the patients at the discrete healthcare entities. As an example, the discrete healthcare entities may include a hospital, clinic, CMS, etc. At step 1320, a metric based on the aggregated patient medical data for each discrete healthcare entity is calculated. In some embodiments, calculating the metrics may include identifying one or more medical procedures based on a number of times each medical procedure has been performed, determining a cost of one or more of the medical procedures, or determining a number of follow-up visits associated with each medical procedure. At step 1330, a report including one or more of the metrics is generated. At step 1340, the report is transmitted to the given one of the discrete healthcare entities.

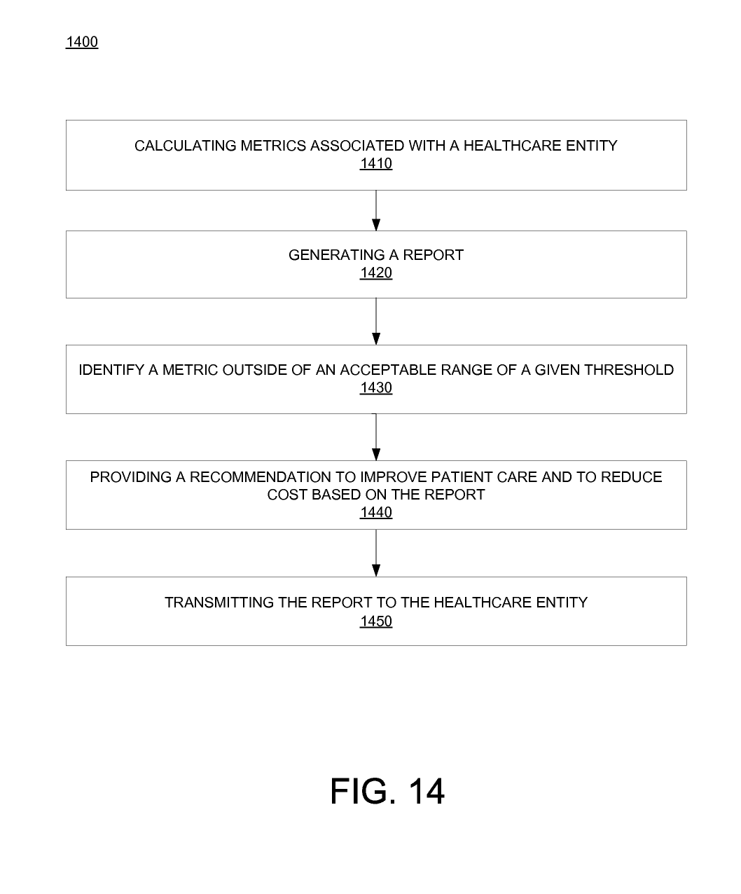

FIG. 14 illustrates another flow chart diagram 1400 for generating a utilization report according to some embodiments. At step 1410, metrics associated with a healthcare entity is calculated. As an example, the aggregated patient data is associated with medical activity of the patients at the discrete healthcare entities. At step 1420 a report associated with the metrics is generated. In some embodiments, one or more of the metrics are normalized based on a size of the discrete healthcare entities. At step 1430, a metric that is outside of an acceptable range of a given threshold is identified. At step 1440, a recommendation to improve patient care and to reduce cost based on the report is provided. At step 1450, the report to the healthcare entity of the plurality of healthcare entities is transmitted.

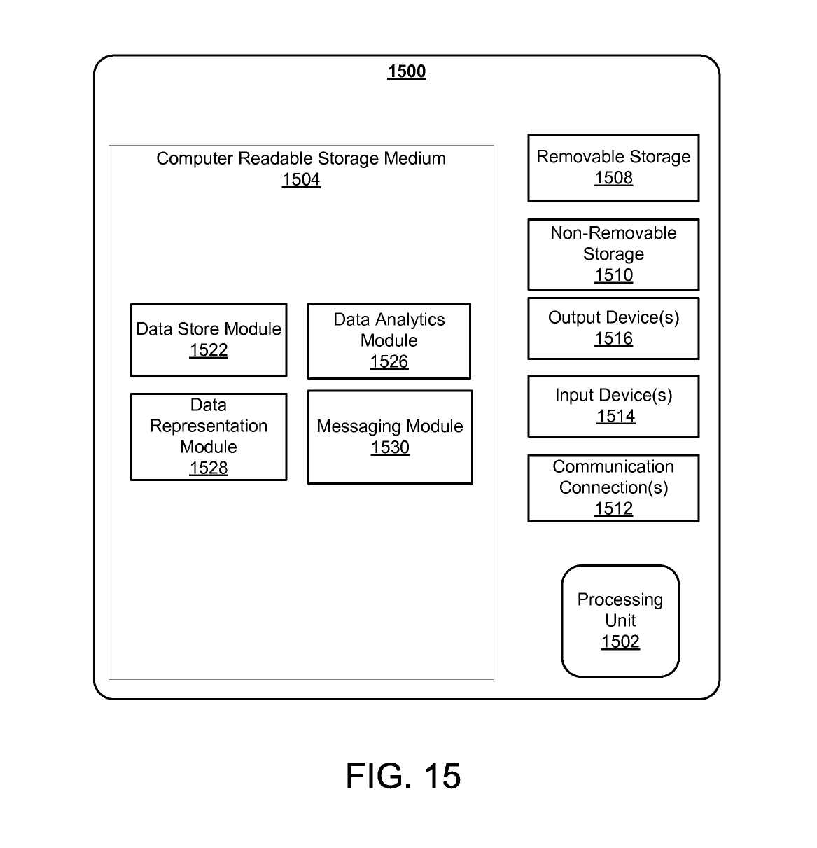

FIG. 15 illustrates a computer system according to some embodiments. As illustrated in FIG. 15, a system module for implementing embodiments includes a general purpose computing system environment, such as computing system environment 1500. Computing system environment 1500 may include, but is not limited to, servers, switches, routers, desktop computers, laptops, tablets, mobile devices, and smartphones. In its most basic configuration, computing system environment 1500 typically includes at least one processing unit 1502 and computer readable storage medium 1504. Depending on the exact configuration and type of computing system environment, computer readable storage medium 1504 may be volatile (such as RAM), non-volatile (such as ROM, flash memory, etc.) or some combination of the two. Portions of computer readable storage medium 1504 when executed generate a report (e.g., processes 1300 and 1400).

Additionally, in various embodiments, computing system environment 1500 may also have other features/functionality. For example, computing system environment 1500 may also include additional storage (removable and/or non-removable) including, but not limited to, magnetic or optical disks or tape. Such additional storage is illustrated by removable storage 1508 and non-removable storage 1510. Computer storage media includes volatile and nonvolatile, removable and non-removable media implemented in any method or technology for storage of information such as computer readable instructions, data structures, program modules or other data. Computer readable medium 1504, removable storage 1508 and nonremovable storage 1510 are all examples of computer storage media. Computer storage media includes, but is not limited to, RAM, ROM, EEPROM, flash memory or other memory technology, expandable memory (e.g., USB sticks, compact flash cards, SD cards), CD-ROM, digital versatile disks (DVD) or other optical storage, magnetic cassettes, magnetic tape, magnetic disk storage or other magnetic storage devices, or any other medium which can be used to store the desired information and which can be accessed by computing system environment 1500. Any such computer storage media may be part of computing system environment 1500.

In some embodiments, computing system environment 1500 may also contain communications connection(s) 1512 that allow it to communicate with other devices. Communications connection(s) 1512 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

Communications connection(s) 1512 may allow computing system environment 1500 to communicate over various networks types including, but not limited to, fibre channel, small computer system interface (SCSI), Bluetooth, Ethernet, Wi-fi, Infrared Data Association (IrDA), Local area networks (LAN), Wireless Local area networks (WLAN), wide area networks (WAN) such as the internet, serial, and universal serial bus (USB). It is appreciated the various network types that communication connection(s) 1512 connect to may run a plurality of network protocols including, but not limited to, transmission control protocol (TCP), user datagram protocol (UDP), internet protocol (IP), real-time transport protocol (RTP), real-time transport control protocol (RTCP), file transfer protocol (FTP), and hypertext transfer protocol (HTTP).

In further embodiments, computing system environment 1500 may also have input device(s) 1514 such as keyboard, mouse, a terminal or terminal emulator (either connected or remotely accessible via telnet, SSH, http, SSL, etc.), pen, voice input device, touch input device, remote control, etc. Output device(s) 1516 such as a display, a terminal or terminal emulator (either connected or remotely accessible via telnet, SSH, http, SSL, etc.), speakers, light emitting diodes (LEDs), etc. may also be included. All these devices are well known in the art and are not discussed at length.

In one embodiment, computer readable storage medium 1504 includes a data store module 1522, data analytics module 1526, data representation module 1528, and a messaging module 1530. The data store 1522 may be similar to data store module 1120 described above and is operable to store aggregated patient data associated with medical activity of the patients at a number of discrete healthcare entities according to flow diagrams 1300 and 1400, for instance. Data analytics module 1526 may be similar to data analytics module 1122 described above and may be used to generate a report comprising one or more metrics of a given one of the discrete healthcare entities, wherein one or more of the metrics are calculated based on the aggregated patient data, as discussed with respect to flows 1300 and 1400. Data representation module 1528 may be similar to data representation module 1124 described above and may be configured to present the report. Messaging module 1530 may be similar to messaging module 1126 described above and may be configured to transmit a report that includes one or more of the metrics to the given one of the healthcare entities.

It is appreciated that implementations according to embodiments of the present invention that are described with respect to a computer system are merely exemplary and not intended to limit the scope of the present invention. For example, embodiments of the present invention may be implemented on devices such as switches and routers, which may contain application specific integrated circuits (ASICs), field programmable gate arrays (FPGAs), etc. It is appreciated that these devices may include a computer readable medium for storing instructions for implementing methods according to flow diagrams 1300 and 1400.

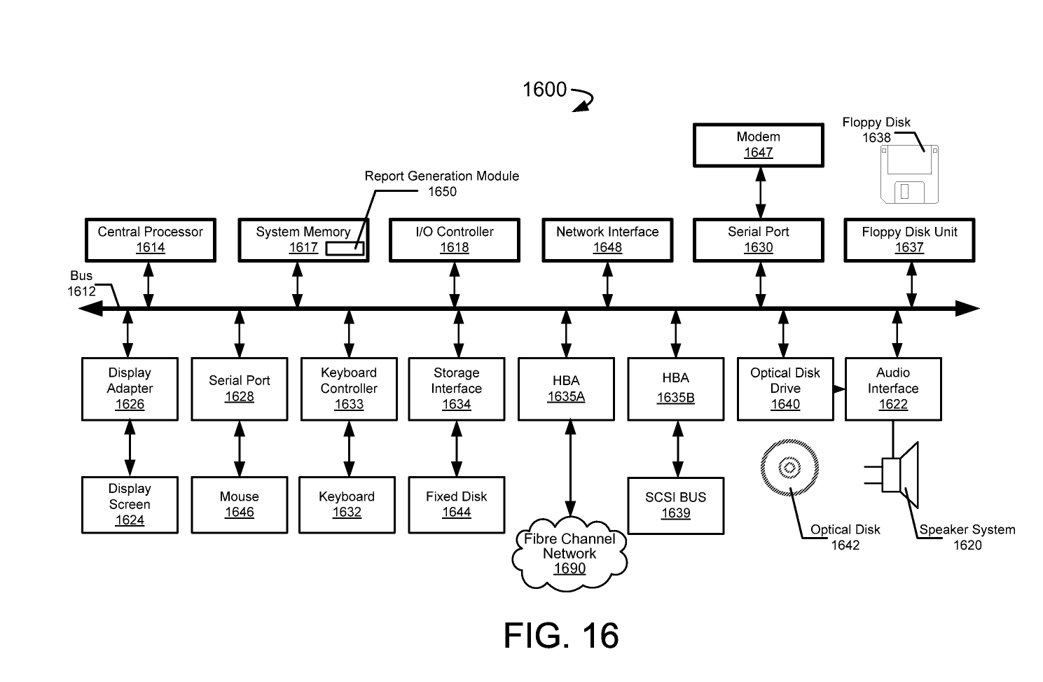

FIG. 16 illustrates a block diagram of another computer system according to some embodiments. FIG. 16 depicts a block diagram of a computer system 1600 suitable for implementing the present disclosure. Computer system 1600 includes a bus 1612 which interconnects major subsystems of computer system 1600, such as a central processor 1614, a system memory 1617 (typically RAM, but which may also include ROM, flash RAM, or the like), an input/output controller 1618, an external audio device, such as a speaker system 1620 via an audio output interface 1622, an external device, such as a display screen 1624 via display adapter 1626, serial ports 1628 and 1630, a keyboard 1632 (interfaced with a keyboard controller 1633), a storage interface 1634, a floppy disk drive 1637 operative to receive a floppy disk 1638, a host bus adapter (HBA) interface card 1635A operative to connect with a Fibre Channel network 1690, a host bus adapter (HBA) interface card 1635B operative to connect to a SCSI bus 1639, and an optical disk drive 1640 operative to receive an optical disk 1642. Also included are a mouse 1646 (or other point-and-click device, coupled to bus 1612 via serial port 1628), a modem 1647 (coupled to bus 1612 via serial port 1630), and a network interface 1648 (coupled directly to bus 1612). It is appreciated that the network interface 1648 may include one or more Ethernet ports, wireless local area network (WLAN) interfaces, etc., but are not limited thereto. System memory 1617 includes a report generation module 1650 which is operable to generate a report that includes recent activities of the patient. According to one embodiment, the report generation module 1650 may include other modules for carrying out various tasks. For example, report generation module 1650 may include data store module 1022, data analytics module 1026, data representation module 1028, and messaging module 1030, as discussed with respect to FIG. 10 above. It is appreciated that the report generation module 1650 may be located anywhere in the system and is not limited to the system memory 1617. As such, residing of the report generation module 1650 within the system memory 1617 is merely exemplary and not intended to limit the scope of the present invention. For example, parts of the report generation module 1650 may reside within the central processor 1614 and/or the network interface 1648 but are not limited thereto.

Bus 1612 allows data communication between central processor 1614 and system memory 1617, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components. Applications resident with computer system 1600 are generally stored on and accessed via a computer readable medium, such as a hard disk drive (e.g., fixed disk 1644), an optical drive (e.g., optical drive 1640), a floppy disk unit 1637, or other storage medium. Additionally, applications can be in the form of electronic signals modulated in accordance with the application and data communication technology when accessed via network modem 1647 or interface 1648.

Storage interface 1634, as with the other storage interfaces of computer system 1600, can connect to a standard computer readable medium for storage and/or retrieval of information, such as a fixed disk drive 1644. Fixed disk drive 1644 may be a part of computer system 1600 or may be separate and accessed through other interface systems. Network interface 1648 may provide multiple connections to other devices. Furthermore, modem 1647 may provide a direct connection to a remote server via a telephone link or to the Internet via an internet service provider (ISP). Network interface 1648 may provide one or more connection to a data network, which may include any number of networked devices. It is appreciated that the connections via the network interface 1648 may be via a direct connection to a remote server via a direct network link to the Internet via a POP (point of presence). Network interface 1648 may provide such connection using wireless techniques, including digital cellular telephone connection, Cellular Digital Packet Data (CDPD) connection, digital satellite data connection or the like.

Many other devices or subsystems (not shown) may be connected in a similar manner (e.g., document scanners, digital cameras and so on). Conversely, all of the devices shown in FIG. 16 need not be present to practice the present disclosure. The devices and subsystems can be interconnected in different ways from that shown in FIG. 16. The operation of a computer system such as that shown in FIG. 16 is readily known in the art and is not discussed in detail in this application. Code to implement the present disclosure can be stored in computer-readable storage media such as one or more of system memory 1617, fixed disk 1644, optical disk 1642, or floppy disk 1638. The operating system provided on computer system 1600 may be MS-DOS®, MS-WINDOWS®, OS/2®, UNIX®, LINUX®, or any other operating system.

Moreover, regarding the signals described herein, those skilled in the art will recognize that a signal can be directly transmitted from a first block to a second block, or a signal can be modified (e.g., amplified, attenuated, delayed, latched, buffered, inverted, filtered, or otherwise modified) between the blocks. Although the signals of the above described embodiment are characterized as transmitted from one block to the next, other embodiments of the present disclosure may include modified signals in place of such directly transmitted signals as long as the informational and/or functional aspect of the signal is transmitted between blocks. To some extent, a signal input at a second block can be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings.

What is claimed is:

1. A system comprising:
a data store module configured to store aggregated patient medical data collected from electronic devices associated with a plurality of discrete healthcare entities;
a data analytics module configured to calculate a metric based on the aggregated patient medical data for each discrete healthcare entity of the plurality of discrete healthcare entities, and wherein the data analytics module is further configured to generate a report associated therewith; and
a messaging module configured to transmit the report to one or more electronic devices associated with the plurality of discrete healthcare entities responsive to the report generation.

2. The system as described in claim 1, wherein the data analytics module is further configured to identify an administrator associated with each healthcare entity of the plurality of discrete healthcare entities.

3. The system as described in claim 1, wherein the messaging module is further configured to transmit a message to an appropriate individual within a discrete healthcare entity of the plurality of discrete healthcare entities responsive to the calculation, wherein the message comprises a recommendation on steps to be taken to improve patient care and to reduce cost based on the report.

4. The system as described in claim 3, wherein the calculated metric comprises a cost of a medical procedure at a discrete healthcare entity, and wherein the recommendation comprises information associated with reducing the cost of the medical procedure.

5. The system as described in claim 3, wherein the calculated metric comprises a number of visits to an emergency department (ED), and wherein the recommendation comprises information associated with an outreach program to follow-up with patients that visited the ED.

6. The system as described in claim 3, wherein the calculated metric comprises a reimbursement amount of a medical procedure, and wherein the recommendation comprises information associated with an outreach program to advertise the medical procedure.

7. The system as described in claim 1, wherein the data analytics module is further configured to normalize the calculated metric based on a size of one of the associated discrete healthcare entity.

8. The system as described in claim 1, wherein the data analytics module is further configured to identify one or more patients associated with the calculated metric.

9. The system as described in claim 1, wherein the aggregated patient data comprises medical claim data.

10. The system as described in claim 1 further comprising a data representation module configured to render the report in a graphical user interface (GUI)), and wherein the data representation module is further configured to provide additional data associated with selected field in the report.

11. A system comprising:
a data analytics module configured to calculate metrics associated with a healthcare entity of a plurality of healthcare entities, wherein the metrics are based on patient medical data received from electronic devices associated with the healthcare entity of the plurality of healthcare entities, wherein the data analytics module is further configured to generate a report associated with the metrics responsive to the calculation, wherein the data analytics module is further configured to identify a metric of the metrics that is outside of an acceptable range of a given threshold, and wherein the data analytics module is further configured to provide a recommendation to improve patient care and to reduce cost based on the report; and
a messaging module configured to transmit the report to an electronic device associated with the healthcare entity of the plurality of healthcare entities responsive to the report generation.

12. The system as described in claim 11, wherein the messaging module is further configured to transmit the report in response to the metric of the metrics being outside the acceptable range of the given threshold.

13. The system as described in claim 11, wherein the calculated metrics comprise a number of times a medical condition is diagnosed, and wherein the recommendation comprises information associated with follow-up care for the diagnosed medical condition.

14. The system as described in claim 11, wherein the calculated metrics comprise a cost of a prescribed branded medication, and wherein the recommendation comprises information associated with a generic equivalent to the branded medication.

15. The system as described in claim 11, wherein the data analytics module is further configured to filter data of one or more patients from the calculation based on a demographic of the patients.

16. The system as described in claim 11 further comprising a data representation module render the report in a graphical user interface (GUI).

17. A system comprising:
a first electronic device configured to transmit patient medical data; and
a second server configured to calculate a metric based on the patient medical data and generate a report associated therewith, and wherein the second electronic device is further configured to transmit the report to an electronic device associated with a discrete healthcare entity responsive to the calculation.

18. The system as described in claim 17, wherein the second electronic device is further configured to calculate a number of times a medical condition is diagnosed based on international classification of diseases (ICD) codes stored at a center for Medicare and Medicaid Services (CMS).

19. The system as described in claim 18, wherein the second electronic device is further configured to group the ICD codes into a categories encompassing a plurality ICD codes.

20. The system as described in claim 17, wherein the report is transmitted to an administrator associated with the discrete healthcare entity.
